(19) United States
(12) Patent Application Publication
(10) Pub. No.: US 2023/0332031 A1
(43) Pub. Date: Oct. 19, 2023

(54) Azeotrope and Azeotrope-like Compositions Comprising Neopentane and Isomers of HFO-1336mzz

(71) Applicant: NOISEAWAER INC., Dallas, TX (US)

(72) Inventors: HARRISON K. MUSYIMI, BEAR, DE (US); MARK L. ROBIN, MIDDLETOWN, DE (US); JASON R. JUHASZ, HOCKESSIN, DE (US)

(73) Assignee: NOISEAWAER INC., Dallas, TX (US)

(21) Appl. No.: 17/767,483

(22) PCT Filed: Oct. 8, 2020
(86) PCT No.: PCT/US2020/054689

§ 371 Date: Apr. 8, 2022

Related U.S. Application Data
(60) Provisional application No. 62/913,319, filed on Oct. 10, 2019.

(51) Int. Cl. C09K 5/04

(52) U.S. Cl. CPC C09K 5/045; C09K 2205/32; C09K 2205/126; C09K 2205/24

(57) ABSTRACT

The present application relates to azeotrope and azeotrope-like compositions comprising neopentane and a compound selected from E-1,1,1,4,4,4-hexafluoro-2-butene (HFO-1336mzz(E)) and Z-1,1,1,4,4,4-hexafluoro-2-butene (HFO-1336mzz(Z)). Methods of using the compositions of the invention in propellant applications, heat transfer applications, and refrigeration applications are also provided.

### TECHNICAL FIELD

The present application relates to azeotrope and azeotrope-like compositions comprising neopentane and a compound selected from E-1,1,1,4,4,4-hexafluoro-2-butene (HFO-1336mzz(E)) and Z-1,1,1,4,4,4-hexafluoro-2-butene (HFO-1336mzz(Z)). The compositions described herein may be useful in a variety of 61 applications including, but not limited to, heat transfer applications, and refrigeration applications.

### BACKGROUND

Many industries have been working for the past few decades to find replacements for the ozone depleting chlorofluorocarbons (CFCs) and hydrochlorofluorocarbons (HCFCs). The CFCs and HCFCs have been employed in a wide range of applications, including their use, for example, as aerosol propellants, refrigerants and heat transfer media. In the search for replacements for these versatile compounds, many industries have turned to the use of hydrofluoroolefins (HFOs).

### SUMMARY

The present application provides, inter alia, compositions comprising:
i) neopentane 2,2-dimethylpropane); and
ii) a compound selected from E-1,1,1,4,4,4-hexafluoro-2-butene HFO-1336mzz(E)) and Z-1,1,1,4,4,4-hexafluoro-2-butene HFO-1336mzz(Z)),
wherein the E-1,1,1,4,4,4-hexafluoro-2-butene or Z-1,1,1,4,4,4-hexafluoro-2-butene is present in the composition in an amount effective to form an azeotrope composition or an azeotrope-like composition with the neopentane.

The present application further provides methods of using the compositions provided herein as propellants and heat transfer agents (e.g., in refrigeration or heat transfer applications).

Unless otherwise defined, all technical and scientific terms used herein have the same meaning as commonly understood by one of ordinary skill in the art to which this invention belongs. Methods and materials are described herein for use in the present invention; other, suitable methods and materials known in the art can also be used. The materials, methods, and examples are illustrative only and not intended to be limiting. All publications, patent applications, patents, sequences, database entries, and other references mentioned herein are incorporated by reference in their entirety. In case of conflict, the present specification, including definitions, will control.

### DESCRIPTION OF DRAWINGS

FIG. 1 displays the vapor/liquid equilibrium curve for a mixture of E-HFO-1336mzz and neopentane at a temperature of 29.88° C., and shows the formation of an azeotrope of composition 0.552 mole fraction E-HFO-1336mzz and 0.448 mole fraction neopentane, which has a vapor pressure of 41.8 psia.

FIG. 2 displays the vapor/liquid equilibrium curve for a mixture of Z-HFO-1336mzz and neopentane at a temperature of 29.90° C., and shows the formation of an azeotrope of composition 0.220 mole fraction Z-HFO-1336mzz and 0.780 mole fraction neopentane, which has a vapor pressure of 31.8 psia.

### DETAILED DESCRIPTION

The present application provides compositions comprising:
i) neopentane 2,2-dimethylpropane); and
ii) a compound selected from E-1,1,1,4,4,4-hexafluoro-2-butene HFO-1336mzz(E)) and Z-1,1,1,4,4,4-hexafluoro-2-butene HFO-1336mzz(Z)),
wherein the E-1,1,1,4,4,4-hexafluoro-2-butene or Z-1,1,1,4,4,4-hexafluoro-2-butene is present in the composition in an amount effective to form an azeotrope composition or an azeotrope-like composition with the neopentane.

### Definitions and Abbreviations

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

As used herein, the term “consisting essentially of” is used to define a composition, method that includes materials, steps, features, components, or elements, in addition to those literally disclosed provided that these additional included materials, steps, features, components, or elements do not materially affect the basic and novel characteristic(s) of the claimed invention, especially the mode of action to achieve the desired result of any of the processes of the present invention. The term “consists essentially of” or “consisting essentially of” occupies a middle ground between “comprising” and “consisting of”.

For example, in some embodiments the composition provided herein consists essentially of:
i) neopentane;
ii) a compound selected from E-1,1,1,4,4,4-hexafluoro-2-butene (HFO-1336mzz(E)) and Z-1,1,1,4,4,4-hexafluoro-2-butene (HFO-1336mzz(Z)),
wherein the E-1,1,1,4,4,4-hexafluoro-2-butene or Z-1,1,1,4,4,4-hexafluoro-2-butene is present in the composition in an amount effective to form an azeotrope composition or an azeotrope-like composition with the neopentane; and
iii) one or more additional components as described herein (wherein the one or more additional components do not materially affect the basic and novel characteristic(s) of the composition).

Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

As used herein, the term “about” is meant to account for variations due to experimental error (e.g., plus or minus approximately 10% of the indicated value). All measurements reported herein are understood to be modified by the term “about”, whether or not the term is explicitly used, unless explicitly stated otherwise.

As used herein, the term “azeotropic composition” refers to a composition where at a given temperature at equilibrium, the boiling point pressure (of the liquid phase) is identical to the dew point pressure (of the vapor phase), i.e., X₂=Y₂. One way to characterize an azeotropic composition is that the vapor produced by partial evaporation or distillation of the liquid has the same composition as the liquid from which it was evaporated or distilled, that is, the admixture distills/refluxes without compositional change. Constant boiling compositions are characterized as azeotropic because they exhibit either a maximum or minimum boiling point, as compared with that of the non-azeotropic mixtures of the same components. Azeotropic compositions are also characterized by a minimum or a maximum in the vapor pressure of the mixture relative to the vapor pressure of the neat components at a constant temperature.

As used herein, the terms “azeotrope-like composition” and “near-azeotropic composition” refer to a composition wherein the difference between the bubble point pressure (“BP”) and dew point pressure (“DP”) of the composition at a particular temperature is less than or equal to 5 percent based upon the bubble point pressure, i.e., [(BP−DP)/BP]×100≤5. As used herein, the terms “3 percent azeotrope-like composition” and “3 percent near-azeotropic composition” shall be understood to mean a composition wherein the difference between the bubble point pressure (“BP”) and dew point pressure (“DP”) of the composition at a particular temperature is less than or equal to 3 percent based upon the bubble point pressure, i.e., [(BP−DP)/BP]×100≤3.

Binary azeotropic or azeotrope-like compositions of substantially constant-boiling mixtures can be characterized, depending upon the conditions chosen, in a number of ways. For example, it is well known by those skilled in the art, that, at different pressures the composition of a given azeotrope or azeotrope-like composition will vary at least to some degree, as will the boiling point temperature. Thus, an azeotropic or azeotrope-like composition of two compounds represents a unique type of relationship but with a variable composition that depends on temperature and/or pressure. Therefore, compositional ranges, rather than fixed compositions, are often used to define azeotropes and azeotrope-like compositions.

For purposes of this invention, “effective amount” refers to the amount of each component of a composition provided herein which, when combined, results in the formation of an azeotropic or azeotrope-like composition. This definition includes the amounts of each component, which amounts may vary depending on the pressure applied to the composition so long as the azeotropic or azeotrope-like compositions continue to exist at the different pressures, but with possible different boiling points. Therefore, effective amount includes the amounts, such as may be expressed in weight percentages, of each component of the compositions of the instant invention which form azeotropic or azeotrope-like compositions at temperatures or pressures other than as described herein.

As used herein, the term “mole fraction” refers to the ratio of the number of moles of one component in the binary composition to the sum of the numbers of moles of each of the two components in said composition (e.g., X₂=m₂/(m₁+m₂).

To determine the relative volatility of any two compounds, a method known as the PTx method can be used. In this procedure, the total absolute pressure in a cell of known volume is measured at a constant temperature for various compositions of the two compounds. Use of the PTx Method is described in detail in “Phase Equilibrium in Process Design”, Wiley-Interscience Publisher, 1970, written by Harold R. Null, on pages 124 to 126; hereby incorporated by reference. The resulting pressure v. liquid composition data are alternately referred to as Vapor Liquid Equilibria data (or “VLE data.”)

These measurements can be converted into equilibrium vapor and liquid compositions in the PTx cell by using an activity coefficient equation model, such as the Non-Random, Two-Liquid (NRTL) equation, to represent liquid phase nonidealities. Use of an activity coefficient equation, such as the NRTL equation is described in detail in “The Properties of Gases and Liquids,” 4th edition, published by McGraw Hill, written by Reid, Prausnitz and Poling, on pages 241 to 387, and in “Phase Equilibria in Chemical Engineering,” published by Butterworth Publishers, 1985, written by Stanley M. Walas, pages 165 to 244. The collection of VLE data, the determination of interaction parameters by regression and the use of an equation of state to predict non-ideal behavior of a system are taught in “Double Azeotropy in Binary Mixtures of NH₃ and CHF₂CF₂,” C.-P. Chai Kao, M. E. Paulaitis, A. Yokozeki, Fluid Phase Equilibria, 127 (1997) 191-203. All of the aforementioned references are hereby incorporated by reference. Without wishing to be bound by any theory or explanation, it is believed that the NRTL equation, together with the PTx cell data, can sufficiently predict the relative volatilities of the compositions provided herein and can therefore predict the behavior of these mixtures in multi-stage separation equipment such as distillation columns.

When an amount, concentration, or other value or parameter is given as either a range, preferred range or a list of upper preferable values and/or lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range.

### Compositions

A composition, comprising:
i) neopentane; and
ii) a compound selected from E-1,1,1,4,4,4-hexafluoro-2-butene and Z-1,1,1,4,4,4-hexafluoro-2-butene.

In some embodiments, the composition provided herein is an azeotrope or azeotrope-like composition. In some embodiments, the composition provided herein is an azeotrope composition. In some embodiments, the composition provided herein is an azeotrope-like composition. In some embodiments, the E-1,1,1,4,4,4-hexafluoro-2-butene or Z-1,1,1,4,4,4-hexafluoro-2-butene is present in the composition in an amount effective to form an azeotrope composition or an azeotrope-like composition with the neopentane.

In some embodiments, the composition provided herein comprises neopentane and E-1,1,1,4,4,4-hexafluoro-2-butene, wherein the E-1,1,1,4,4,4-hexafluoro-2-butene is present in the composition in an amount effective to form an azeotrope composition or an azeotrope-like composition with the neopentane. In some embodiments, the composition comprising neopentane and E-1,1,1,4,4,4-hexafluoro-2-butene is an azeotrope composition (i.e., an azeotropic composition). In some embodiments, the composition comprising neopentane and E-1,1,1,4,4,4-hexafluoro-2-butene is an azeotrope-like composition.

In some embodiments, the composition comprising neopentane and E-1,1,1,4,4,4-hexafluoro-2-butene comprises from about 40 to about 60 mol % neopentane, for example, about 40 to about 55, about 40 to about 50, about 40 to about 45, about 45 to about 60, about 45 to about 55, about 45 to about 50, about 50 to about 60, about 50 to about 55, or about 55 to about 60 mol % neopentane. In some embodiments, the composition comprising neopentane and E-1,1,1,4,4,4-hexafluoro-2-butene comprises from about 40 to about 50 mol % neopentane.

In some embodiments, the composition comprising neopentane and E-1,1,1,4,4,4-hexafluoro-2-butene comprises from about 60 to about 40 mol % E-1,1,1,4,4,4-hexafluoro-2-butene, for example, about 60 to about 45, about 60 to about 50, about 60 to about 55, about 55 to about 40, about 55 to about 45, about 55 to about 50, about 50 to about 40, about 50 to about 45, or about 45 to about 40 mol % E-1,1,1,4,4,4-hexafluoro-2-butene. In some embodiments, the composition comprising neopentane and E-1,1,1,4,4,4-hexafluoro-2-butene comprises from 60 to about 50 mol % E-1,1,1,4,4,4-hexafluoro-2-butene.

In some embodiments, the composition comprises from about 40 to about 60 mol % neopentane and about 60 to about 40 mol % E-1,1,1,4,4,4-hexafluoro-2-butene. In some embodiments, the composition comprises from about 40 to about 60 mol % neopentane and about 60 to about 40 mol % E-1,1,1,4,4,4-hexafluoro-2-butene, and has a boiling point of from about −40° C. to about 120° C. at a pressure of from about 2 psi to about 390 psi.

In some embodiments, the composition comprises from about 40 to about 50 mol % neopentane and about 60 to about 50 mol % E-1,1,1,4,4,4-hexafluoro-2-butene. In some embodiments, the composition comprises from about 40 to about 50 mol % neopentane and about 60 to about 50 mol % E-1,1,1,4,4,4-hexafluoro-2-butene, and has a boiling point of from about 0.9° C. to about 128° C. at a pressure of from about 1 atm to about 30 atm.

In some embodiments, the composition comprising neopentane and E-1,1,1,4,4,4-hexafluoro-2-butene comprises 98.0 to about 99.9 mol % neopentane, for example, about 98.0 to about 99.8, about 98.0 to about 99.5, about 98.0 to about 99.3, about 98.0 to about 99.0, about 98.0 to about 98.8, about 98.0 to about 98.5, about 98.5 to about 99.9, about 98.5 to about 99.8, about 98.5 to about 99.5, about 98.5 to about 99.3, about 98.5 to about 99.0, about 98.5 to about 98.8, about 98.8 to about 99.9, about 98.8 to about 99.8, about 98.8 to about 99.5, about 98.8 to about 99.3, about 98.8 to about 99.0, about 99.0 to about 99.9, about 99.0 to about 99.8, about 99.0 to about 99.5, about 99.0 to about 99.3, about 99.3 to about 99.9, about 99.3 to about 99.8, about 99.3 to about 99.5, about 99.5 to about 99.9, about 99.5 to about 99.8, or about 99.8 to about 99.9 mol % neopentane. In some embodiments, the composition comprising neopentane and E-1,1,1,4,4,4-hexafluoro-2-butene comprises from about 98.2 to about 99.8 mol % neopentane.

In some embodiments, the composition comprising neopentane and E-1,1,1,4,4,4-hexafluoro-2-butene comprises about 2.0 to about 0.1 mol % E-1,1,1,4,4,4-hexafluoro-2-butene, for example, about 2.0 to about 0.2, about 2.0 to about 0.5, about 2.0 to about 0.7, about 2.0 to about 1.0, about 2.0 to about 1.2, about 2.0 to about 1.5, about 1.5 to about 0.1, about 1.5 to about 0.2, about 1.5 to about 0.5, about 1.5 to about 0.7, about 1.5 to about 1.0, about 1.5 to about 1.2, about 1.2 to about 0.1, about 1.2 to about 0.2, about 1.2 to about 0.5, about 1.2 to about 0.7, about 1.2 to about 1.0, about 1.0 to about 0.1, about 1.0 to about 0.2, about 1.0 to about 0.5, about 1.0 to about 0.7, about 0.7 to about 0.1, about 0.7 to about 0.2, about 0.7 to about 0.5, about 0.5 to about 0.1, about 0.5 to about 0.2, or about 0.2 to about 0.1 mol % E-1,1,1,4,4,4-hexafluoro-2-butene.

In some embodiments, the composition comprising neopentane and E-1,1,1,4,4,4-hexafluoro-2-butene comprises about 1.6 to about 0.2 mol % E-1,1,1,4,4,4-hexafluoro-2-butene.

In some embodiments, the composition comprising neopentane and E-1,1,1,4,4,4-hexafluoro-2-butene comprises from about 98.4 to about 99.8 mol % neopentane and about 1.6 to about 0.2 mol % E-1,1,1,4,4,4-hexafluoro-2-butene. In some embodiments, the composition comprising neopentane and E-1,1,1,4,4,4-hexafluoro-2-butene comprises from about 98.4 to about 99.8 mol % neopentane and about 1.6 to about 0.2 mol % E-1,1,1,4,4,4-hexafluoro-2-butene, and has a boiling point of from about 8.3° C. to about 9.3° C. at a pressure of about 1 atm.

In some embodiments, the composition comprising neopentane and E-1,1,1,4,4,4-hexafluoro-2-butene comprises from about 35 to about 65 mol % neopentane, for example, about 35 to about 60, about 35 to about 55, about 35 to about 50, about 35 to about 45, about 35 to about 40, about 40 to about 65, about 40 to about 60, about 40 to about 55, about 40 to about 50, about 40 to about 45, about 45 to about 65, about 45 to about 60, about 45 to about 55, about 45 to about 50, about 50 to about 65, about 50 to about 60, about 50 to about 55, about 55 to about 65, about 55 to about 60, or about 60 to about 65 mol % neopentane. In some embodiments, the composition comprising neopentane and E-1,1,1,4,4,4-hexafluoro-2-butene comprises from about 38.4 to about 62.6 mol % neopentane.

In some embodiments, the composition comprising neopentane and E-1,1,1,4,4,4-hexafluoro-2-butene comprises from about 70 to about 35 mol % E-1,1,1,4,4,4-hexafluoro-2-butene, for example, about 70 to about 40, about 70 to about 45, about 70 to about 50, about 70 to about 55, about 70 to about 60, about 70 to about 65, about 65 to about 35, about 65 to about 40, about 65 to about 45, about 65 to about 50, about 65 to about 55, about 65 to about 60, about 60 to about 35, about 60 to about 40, about 60 to about 45, about 60 to about 50, about 60 to about 55, about 55 to about 35, about 55 to about 40, about 55 to about 45, about 55 to about 50, about 50 to about 35, about 50 to about 40, about 50 to about 45, about 45 to about 35, about 45 to about 40, or about 40 to about 35 mol % E-1,1,1,4,4,4-hexafluoro-2-butene. In some embodiments, the composition comprising neopentane and E-1,1,1,4,4,4-hexafluoro-2-butene comprises from about 65.2 to about 37.4 mol % E-1,1,1,4,4,4-hexafluoro-2-butene.

In some embodiments, the composition comprising neopentane and E-1,1,1,4,4,4-hexafluoro-2-butene comprises from about 38.4 to about 62.6 mol % neopentane and about 65.2 to about 37.4 mol % E-1,1,1,4,4,4-hexafluoro-2-butene. In some embodiments, the composition comprising neopentane and E-1,1,1,4,4,4-hexafluoro-2-butene comprises from about 38.4 to about 62.6 mol % neopentane and about 65.2 to about 37.4 mol % E-1,1,1,4,4,4-hexafluoro-2-butene, and has a boiling point of from about 0.9° C. to about 1.2° C. at a pressure of about 1 atm.

In some embodiments, the composition comprising neopentane and E-1,1,1,4,4,4-hexafluoro-2-butene comprises about 0.1 to about 3.0 mol % neopentane, for example, about 0.1 to about 2.8, about 0.1 to about 2.5, about 0.1 to about 2.0, about 0.1 to about 1.5, about 0.1 to about 1.0, about 0.1 to about 0.5, about 0.5 to about 3.0, about 0.5 to about 2.8, about 0.5 to about 2.5, about 0.5 to about 2.0, about 0.5 to about 1.5, about 0.5 to about 1.0, about 1.0 to about 3.0, about 1.0 to about 2.8, about 1.0 to about 2.5, about 1.0 to about 2.0, about 1.0 to about 1.5, about 1.5 to about 3.0, about 1.5 to about 2.8, about 1.5 to about 2.5, about 1.5 to about 2.0, about 2.0 to about 3.0, about 2.0 to about 2.8, about 2.0 to about 2.5, about 2.5 to about 3.0, about 2.5 to about 2.8, or about 2.8 to about 3.0 mol % neopentane. In some embodiments, the composition comprising neopentane and E-1,1,1,4,4,4-hexafluoro-2-butene comprises from about 0.2 to about 2.8 mol % neopentane.

In some embodiments, the composition comprising neopentane and E-1,1,1,4,4,4-hexafluoro-2-butene comprises about 99.9 to about 97.0 mol % E-1,1,1,4,4,4-hexafluoro-2-butene, for example, about 99.9 to about 97.2, about 99.9 to about 97.5, about 99.9 to about 98.0, about 99.9 to about 98.5, about 99.9 to about 99.0, about 99.9 to about 99.8, about 99.8 to about 97.0, about 99.8 to about 97.2, about 99.8 to about 97.5, about 99.8 to about 98.0, about 99.8 to about 98.5, about 99.8 to about 99.0, about 99.0 to about 97.0, about 99.0 to about 97.2, about 99.0 to about 97.5, about 99.0 to about 98.0, about 99.0 to about 98.5, about 98.5 to about 97.0, about 98.5 to about 97.2, about 98.5 to about 97.5, about 98.5 to about 98.0, about 98.0 to about 97.0, about 98.0 to about 97.2, about 98.0 to about 97.5, about 97.5 to about 97.0, about 97.5 to about 97.2, or about 97.2 to about 97.0 mol % E-1,1,1,4,4,4-hexafluoro-2-butene. In some embodiments, the composition comprising neopentane and E-1,1,1,4,4,4-hexafluoro-2-butene comprises about 99.8 to about 97.2 mol % E-1,1,1,4,4,4-hexafluoro-2-butene.

In some embodiments, the composition comprising neopentane and E-1,1,1,4,4,4-hexafluoro-2-butene comprises from about 0.2 to about 2.8 mol % neopentane and about 99.8 to about 97.2 mol % E-1,1,1,4,4,4-hexafluoro-2-butene. In some embodiments, the composition comprising neopentane and E-1,1,1,4,4,4-hexafluoro-2-butene comprises from about 0.2 to about 2.8 mol % neopentane and about 99.8 to about 97.2 mol % E-1,1,1,4,4,4-hexafluoro-2-butene, and has a boiling point of from about 6.3° C. to about 7.4° C. at a pressure of about 1 atm.

In some embodiments, the composition comprising neopentane and E-1,1,1,4,4,4-hexafluoro-2-butene comprises:
from about 99.8 to about 98.2 mol % neopentane and about 0.2 to about 1.8 mol % E-1,1,1,4,4,4-hexafluoro-2-butene; or
from about 71.6 to about 47.6 mol % neopentane and about 28.4 to about 52.4 mol % E-1,1,1,4,4,4-hexafluoro-2-butene; or
from about 1.2 to about 0.2 mol % neopentane and about 98.8 to about 99.8 mol % E-1,1,1,4,4,4-hexafluoro-2-butene; or
from about 99.8 to about 98.4 mol % neopentane and about 0.2 to about 1.6 mol % E-1,1,1,4,4,4-hexafluoro-2-butene; or
from about 66.6 to about 40.8 mol % neopentane and about 33.4 to about 59.2 mol % E-1,1,1,4,4,4-hexafluoro-2-butene; or
from about 1.8 to about 0.2 mol % neopentane and about 98.2 to about 99.8 mol % E-1,1,1,4,4,4-hexafluoro-2-butene; or
from about 62.8 to about 35.2 mol % neopentane and about 37.2 to about 64.8 mol % E-1,1,1,4,4,4-hexafluoro-2-butene; or
from about 2.6 to about 0.2 mol % neopentane and about 97.4 to about 99.8 mol % E-1,1,1,4,4,4-hexafluoro-2-butene; or
from about 59.8 to about 30.2 mol % neopentane and about 40.2 to about 69.8 mol % E-1,1,1,4,4,4-hexafluoro-2-butene; or
from about 3.4 to about 0.2 mol % neopentane and about 96.6 to about 99.8 mol % E-1,1,1,4,4,4-hexafluoro-2-butene; or
from about 58.4 to about 28.2 mol % neopentane and about 41.6 to about 71.8 mol % E-1,1,1,4,4,4-hexafluoro-2-butene; or
from about 3.8 to about 0.2 mol % neopentane and about 96.2 to about 99.8 mol % E-1,1,1,4,4,4-hexafluoro-2-butene; or
from about 57.2 to about 26.4 mol % neopentane and about 42.8 to about 73.6 mol % E-1,1,1,4,4,4-hexafluoro-2-butene; or
from about 4.4 to about 0.2 mol % neopentane and about 95.6 to about 99.8 mol % E-1,1,1,4,4,4-hexafluoro-2-butene; or
from about 55.4 to about 23.6 mol % neopentane and about 44.6 to about 76.4 mol % E-1,1,1,4,4,4-hexafluoro-2-butene; or
from about 5.2 to about 99.1 mol % neopentane and about 94.8 to about 0.9 mol % E-1,1,1,4,4,4-hexafluoro-2-butene; or
from about 99.8 to about 98.6 mol % neopentane and about 0.2 to about 1.4 mol % E-1,1,1,4,4,4-hexafluoro-2-butene; or
from about 53.8 to about 23.2 mol % neopentane and about 46.2 to about 76.8 mol % E-1,1,1,4,4,4-hexafluoro-2-butene; or
from about 5.4 to about 0.2 mol % neopentane and about 94.6 to about 99.8 mol % E-1,1,1,4,4,4-hexafluoro-2-butene; or
from about 56 to about 24.4 mol % neopentane and about 44.0 to about 75.6 mol % E-1,1,1,4,4,4-hexafluoro-2-butene; or
from about 4.6 to about 0.2 mol % neopentane and about 95.4 to about 99.8 mol % E-1,1,1,4,4,4-hexafluoro-2-butene; or
from about 57.2 to about 3.8 mol % neopentane and about 42.8 to about 96.2 mol % E-1,1,1,4,4,4-hexafluoro-2-butene; or
from about 2.6 to about 0.2 mol % neopentane and about 97.4 to about 99.8 mol % E-1,1,1,4,4,4-hexafluoro-2-butene.

In some embodiments, the composition comprising neopentane and E-1,1,1,4,4,4-hexafluoro-2-butene comprises:
from about 99.8 to about 98.2 mol % neopentane and about 0.2 to about 1.8 mol % E-1,1,1,4,4,4-hexafluoro-2-butene; or
from about 71.6 to about 47.6 mol % neopentane and about 28.4 to about 52.4 mol % E-1,1,1,4,4,4-hexafluoro-2-butene; or
from about 1.2 to about 0.2 mol % neopentane and about 98.8 to about 99.8 mol % E-1,1,1,4,4,4-hexafluoro-2-butene; or
from about 99.8 to about 98.4 mol % neopentane and about 0.2 to about 1.6 mol % E-1,1,1,4,4,4-hexafluoro-2-butene; or
from about 66.6 to about 40.8 mol % neopentane and about 33.4 to about 59.2 mol % E-1,1,1,4,4,4-hexafluoro-2-butene; or
from about 1.8 to about 0.2 mol % neopentane and about 98.2 to about 99.8 mol % E-1,1,1,4,4,4-hexafluoro-2-butene; or
from about 62.8 to about 35.2 mol % neopentane and about 37.2 to about 64.8 mol % E-1,1,1,4,4,4-hexafluoro-2-butene; or
from about 2.6 to about 0.2 mol % neopentane and about 97.4 to about 99.8 mol % E-1,1,1,4,4,4-hexafluoro-2-butene; or
from about 59.8 to about 30.2 mol % neopentane and about 40.2 to about 69.8 mol % E-1,1,1,4,4,4-hexafluoro-2-butene; or
from about 3.4 to about 0.2 mol % neopentane and about 96.6 to about 99.8 mol % E-1,1,1,4,4,4-hexafluoro-2-butene; or
from about 58.4 to about 28.2 mol % neopentane and about 41.6 to about 71.8 mol % E-1,1,1,4,4,4-hexafluoro-2-butene; or
from about 3.8 to about 0.2 mol % neopentane and about 96.2 to about 99.8 mol % E-1,1,1,4,4,4-hexafluoro-2-butene; or
from about 57.2 to about 26.4 mol % neopentane and about 42.8 to about 73.6 mol % E-1,1,1,4,4,4-hexafluoro-2-butene; or
from about 4.4 to about 0.2 mol % neopentane and about 95.6 to about 99.8 mol % E-1,1,1,4,4,4-hexafluoro-2-butene; or
from about 55.4 to about 23.6 mol % neopentane and about 44.6 to about 76.4 mol % E-1,1,1,4,4,4-hexafluoro-2-butene; or
from about 5.2 to about 99.1 mol % neopentane and about 94.8 to about 0.9 mol % E-1,1,1,4,4,4-hexafluoro-2-butene; or
from about 99.8 to about 98.6 mol % neopentane and about 0.2 to about 1.4 mol % E-1,1,1,4,4,4-hexafluoro-2-butene; or
from about 53.8 to about 23.2 mol % neopentane and about 46.2 to about 76.8 mol % E-1,1,1,4,4,4-hexafluoro-2-butene; or
from about 5.4 to about 0.2 mol % neopentane and about 94.6 to about 99.8 mol % E-1,1,1,4,4,4-hexafluoro-2-butene; or
from about 56 to about 24.4 mol % neopentane and about 44.0 to about 75.6 mol % E-1,1,1,4,4,4-hexafluoro-2-butene; or
from about 4.6 to about 0.2 mol % neopentane and about 95.4 to about 99.8 mol % E-1,1,1,4,4,4-hexafluoro-2-butene; or
from about 57.2 to about 3.8 mol % neopentane and about 42.8 to about 96.2 mol % E-1,1,1,4,4,4-hexafluoro-2-butene; or
from about 2.6 to about 0.2 mol % neopentane and about 97.4 to about 99.8 mol % E-1,1,1,4,4,4-hexafluoro-2-butene;
wherein the composition has a boiling point of from about −40° C. to about 120° C. at a pressure of about 1 atm, for example, about −40° C. to about 100° C., about −40° C. to about 80° C., about −40° C. to about 60° C., about −40° C. to about 40° C., about −40° C. to about 20° C., about −40° C. to about 0° C., about −40° C. to about −20° C., about −20° C. to about 120° C., about −20° C. to about 100° C., about −20° C. to about 80° C., about −20° C. to about 60° C., about −20° C. to about 40° C., about −20° C. to about 20° C., about −20° C. to about 0° C., about 0° C. to about 120° C., about 0° C. to about 100° C., about 0° C. to about 80° C., about 0° C. to about 60° C., about 0° C. to about 40° C., about 0° C. to about 20° C., about 20° C. to about 120° C., about 20° C. to about 100° C., about 20° C. to about 80° C., about 20° C. to about 60° C., about 20° C. to about 40° C., about 40° C. to about 120° C., about 40° C. to about 100° C., about 40° C. to about 80° C., about 40° C. to about 60° C., about 60° C. to about 120° C., about 60° C. to about 100° C., about 60° C. to about 80° C., about 80° C. to about 120° C., about 80° C. to about 100° C., or about 100° C. to about 120° C.

In some embodiments, the composition comprising neopentane and E-1,1,1,4,4,4-hexafluoro-2-butene has a boiling point of about −40° C. at a pressure of about 1 atm.

In some embodiments, the composition comprising neopentane and E-1,1,1,4,4,4-hexafluoro-2-butene has a boiling point of about −20° C. at a pressure of about 1 atm.

In some embodiments, the composition comprising neopentane and E-1,1,1,4,4,4-hexafluoro-2-butene has a boiling point of about 0° C. at a pressure of about 1 atm.

In some embodiments, the composition comprising neopentane and E-1,1,1,4,4,4-hexafluoro-2-butene has a boiling point of about 20° C. at a pressure of about 1 atm.

In some embodiments, the composition comprising neopentane and E-1,1,1,4,4,4-hexafluoro-2-butene has a boiling point of about 30° C. at a pressure of about 1 atm.

In some embodiments, the composition comprising neopentane and E-1,1,1,4,4,4-hexafluoro-2-butene has a boiling point of about 40° C. at a pressure of about 1 atm.

In some embodiments, the composition comprising neopentane and E-1,1,1,4,4,4-hexafluoro-2-butene has a boiling point of about 60° C. at a pressure of about 1 atm.

In some embodiments, the composition comprising neopentane and E-1,1,1,4,4,4-hexafluoro-2-butene has a boiling point of about 80° C. at a pressure of about 1 atm.

In some embodiments, the composition comprising neopentane and E-1,1,1,4,4,4-hexafluoro-2-butene has a boiling point of about 100° C. at a pressure of about 1 atm.

In some embodiments, the composition comprising neopentane and E-1,1,1,4,4,4-hexafluoro-2-butene has a boiling point of about 120° C. at a pressure of about 1 atm.

In some embodiments, the composition provided herein comprises neopentane and Z-1,1,1,4,4,4-hexafluoro-2-butene, wherein the Z-1,1,1,4,4,4-hexafluoro-2-butene is present in the composition in an amount effective to form an azeotrope composition or an azeotrope-like composition with the neopentane. In some embodiments, the composition comprising neopentane and Z-1,1,1,4,4,4-hexafluoro-2-butene is an azeotrope composition (i.e., an azeotropic composition). In some embodiments, the composition comprising neopentane and Z-1,1,1,4,4,4-hexafluoro-2-butene is an azeotrope-like composition.

In some embodiments, the composition comprising neopentane and Z-1,1,1,4,4,4-hexafluoro-2-butene comprises from about 60 to about 95 mol % neopentane, for example, about 60 to about 90, about 60 to about 85, about 60 to about 80, about 60 to about 75, about 60 to about 70, about 65 to about 95, about 65 to about 90, about 65 to about 85, about 65 to about 80, about 65 to about 75, about 70 to about 95, about 70 to about 90, about 70 to about 85, about 70 to about 80, about 75 to about 95, about 75 to about 90, about 75 to about 85, about 80 to about 95, about 80 to about 90, or about 85 to about 95 mol % neopentane. In some embodiments, the composition comprising neopentane and Z-1,1,1,4,4,4-hexafluoro-2-butene comprises from about 60 to about 93 mol % neopentane.

In some embodiments, the composition comprising neopentane and Z-1,1,1,4,4,4-hexafluoro-2-butene comprises from about 40 to about 5 mol % Z-1,1,1,4,4,4-hexafluoro-2-butene, for example, about 40 to about 10, about 40 to about 15, about 40 to about 20, about 40 to about 25, about 40 to about 30, about 40 to about 35, about 35 to about 5, about 35 to about 10, about 35 to about 15, about 35 to about 20, about 35 to about 25, about 35 to about 30, about 30 to about 5, about 30 to about 10, about 30 to about 15, about 30 to about 20, about 30 to about 25, about 25 to about 5, about 25 to about 10, about 25 to about 15, about 25 to about 20, about 20 to about 5, about 20 to about 10, about 20 to about 15, about 15 to about 5, about 15 to about 10, or about 10 to about 5 mol % Z-1,1,1,4,4,4-hexafluoro-2-butene. In some embodiments, the composition comprising neopentane and Z-1,1,1,4,4,4-hexafluoro-2-butene comprises from about 40 to about 7 mol % Z-1,1,1,4,4,4-hexafluoro-2-butene.

In some embodiments, the composition comprising neopentane and Z-1,1,1,4,4,4-hexafluoro-2-butene comprises from about 60 to about 93 mol % neopentane and about 40 to about 7 mol % Z-1,1,1,4,4,4-hexafluoro-2-butene. In some embodiments, the composition comprising neopentane and Z-1,1,1,4,4,4-hexafluoro-2-butene comprises from about 60 to about 93 mol % neopentane and about 40 to about 7 mol % Z-1,1,1,4,4,4-hexafluoro-2-butene, and has a boiling point of from about −40° C. to about 120° C. at a pressure of from about 1.5 psi to about 310 psi.

In some embodiments, the composition comprising neopentane and Z-1,1,1,4,4,4-hexafluoro-2-butene comprises from about 50 to about 85 mol % neopentane, for example, about 50 to about 80, about 50 to about 75, about 50 to about 70, about 50 to about 65, about 50 to about 60, about 50 to about 55, about 55 to about 85, about 55 to about 80, about 55 to about 75, about 55 to about 70, about 55 to about 65, about 55 to about 60, about 60 to about 85, about 60 to about 80, about 60 to about 75, about 60 to about 70, about 60 to about 65, about 65 to about 85, about 65 to about 80, about 65 to about 75, about 65 to about 70, about 70 to about 85, about 70 to about 80, about 70 to about 75, about 75 to about 85, about 75 to about 80, or about 80 to about 85 mol % neopentane. In some embodiments, the composition comprising neopentane and Z-1,1,1,4,4,4-hexafluoro-2-butene comprises from about 56 to about 83 mol % neopentane.

In some embodiments, the composition comprising neopentane and Z-1,1,1,4,4,4-hexafluoro-2-butene comprises from about 50 to about 15 mol % Z-1,1,1,4,4,4-hexafluoro-2-butene, for example, about 50 to about 20, about 50 to about 25, about 50 to about 30, about 50 to about 35, about 50 to about 40, about 50 to about 45, about 45 to about 15, about 45 to about 20, about 45 to about 25, about 45 to about 30, about 45 to about 35, about 45 to about 40, about 40 to about 15, about 40 to about 20, about 40 to about 25, about 40 to about 30, about 40 to about 35, about 35 to about 15, about 35 to about 20, about 35 to about 25, about 35 to about 30, about 30 to about 15, about 30 to about 20, about 30 to about 25, about 25 to about 15, about 25 to about 20, or about 20 to about 15 mol % Z-1,1,1,4,4,4-hexafluoro-2-butene. In some embodiments, the composition comprising neopentane and Z-1,1,1,4,4,4-hexafluoro-2-butene comprises from about 44 to about 17 mol % Z-1,1,1,4,4,4-hexafluoro-2-butene.

In some embodiments, the composition comprising neopentane and Z-1,1,1,4,4,4-hexafluoro-2-butene comprises from about 56 to about 83 mol % neopentane and about 44 to about 17 mol % Z-1,1,1,4,4,4-hexafluoro-2-butene. In some embodiments, the composition comprising neopentane and Z-1,1,1,4,4,4-hexafluoro-2-butene comprises from about 56 to about 83 mol % neopentane and about 44 to about 17 mol % Z-1,1,1,4,4,4-hexafluoro-2-butene, and has a boiling point of from about 5° C. to about 145° C. at a pressure of from about 1 atm to about 30 atm.

In some embodiments, the composition comprising neopentane and Z-1,1,1,4,4,4-hexafluoro-2-butene comprises from about 99.9 to about 75.0 mol % neopentane, for example, about 99.9 to about 80.0, about 99.9 to about 85.0, about 99.9 to about 90.0, about 99.9 to about 95.0, about 99.9 to about 99.0, about 99.9 to about 99.6, about 99.6 to about 80.0, about 99.6 to about 85.0, about 99.6 to about 90.0, about 99.6 to about 95.0, about 99.6 to about 99.0, about 99.0 to about 80.0, about 99.0 to about 85.0, about 99.0 to about 90.0, about 99.0 to about 95, about 95.0 to about 80.0, about 95.0 to about 85.0, about 95.0 to about 90.0, about 90.0 to about 80.0, about 90.0 to about 85.0, or about 85.0 to about 80.0 mol % neopentane. In some embodiments, the composition comprising neopentane and Z-1,1,1,4,4,4-hexafluoro-2-butene comprises from about 99.6 to about 79.2 mol % neopentane.

In some embodiments, the composition comprising neopentane and Z-1,1,1,4,4,4-hexafluoro-2-butene comprises from about 0.1 to about 25.0 mol % Z-1,1,1,4,4,4-hexafluoro-2-butene, for example, about 0.1 to about 20.0, about 0.1 to about 15.0, about 0.1 to about 10.0, about 0.1 to about 5.0, about 0.1 to about 1.0, about 0.1 to about 0.4, about 0.4 to about 25.0, about 0.4 to about 20.0, about 0.4 to about 15.0, about 0.4 to about 10.0, about 0.4 to about 5.0, about 0.4 to about 1.0, about 1.0 to about 25.0, about 1.0 to about 20.0, about 1.0 to about 15.0, about 1.0 to about 10.0, about 1.0 to about 5.0, about 5.0 to about 25.0, about 5.0 to about 20.0, about 5.0 to about 15.0, about 5.0 to about 10.0, about 10.0 to about 25.0, about 10.0 to about 20.0, about 10.0 to about 15.0, about 15.0 to about 25.0, about 15.0 to about 20.0, or about 20.0 to about 25.0 mol % Z-1,1,1,4,4,4-hexafluoro-2-butene. In some embodiments, the composition comprising neopentane and Z-1,1,1,4,4,4-hexafluoro-2-butene comprises from about 0.4 to about 20.8 mol % Z-1,1,1,4,4,4-hexafluoro-2-butene.

In some embodiments, the composition comprising neopentane and Z-1,1,1,4,4,4-hexafluoro-2-butene comprises from about 99.6 to about 79.2 mol % neopentane and about 0.4 to about 20.8 mol % Z-1,1,1,4,4,4-hexafluoro-2-butene. In some embodiments, the composition comprising neopentane and Z-1,1,1,4,4,4-hexafluoro-2-butene comprises from about 99.6 to about 79.2 mol % neopentane and about 0.4 to about 20.8 mol % Z-1,1,1,4,4,4-hexafluoro-2-butene, and has a boiling point of from about 7.8° C. to about 9.4° C. at a pressure of about 1 atm.

In some embodiments, the composition comprising neopentane and Z-1,1,1,4,4,4-hexafluoro-2-butene comprises from about 4.0 to about 1.0 mol % neopentane, for example, about 4.0 to about 1.5, about 4.0 to about 2.0, about 4.0 to about 2.5, about 4.0 to about 3.0, about 4.0 to about 3.5, about 3.5 to about 1.0, about 3.5 to about 1.5, about 3.5 to about 2.0, about 3.5 to about 2.5, about 3.5 to about 3.0, about 3.0 to about 1.0, about 3.0 to about 1.5, about 3.0 to about 2.0, about 3.0 to about 2.5, about 2.5 to about 1.0, about 2.5 to about 1.5, about 2.5 to about 2.0, about 2.0 to about 1.0, about 2.0 to about 1.5, or about 1.5 to about 1.0 mol % neopentane. In some embodiments, the composition comprising neopentane and Z-1,1,1,4,4,4-hexafluoro-2-butene comprises from about 3.2 to about 1.6 mol % neopentane.

In some embodiments, the composition comprising neopentane and Z-1,1,1,4,4,4-hexafluoro-2-butene comprises from about 96.0 to about 99.0 mol % Z-1,1,1,4,4,4-hexafluoro-2-butene, for example, about 96.0 to about 98.5, about 96.0 to about 98.0, about 96.0 to about 97.5, about 96.0 to about 97.0, about 96.0 to about 96.5, about 96.5 to about 99.0, about 96.5 to about 98.5, about 96.5 to about 98.0, about 96.5 to about 97.5, about 96.5 to about 97.0, about 97.0 to about 99.0, about 97.0 to about 98.5, about 97.0 to about 98.0, about 97.0 to about 97.5, about 97.5 to about 99.0, about 97.5 to about 98.5, about 97.5 to about 98.0, about 98.0 to about 99.0, about 98.0 to about 98.5, or about 98.5 to about 99.0 mol % Z-1,1,1,4,4,4-hexafluoro-2-butene. In some embodiments, the composition comprising neopentane and Z-1,1,1,4,4,4-hexafluoro-2-butene comprises from about 96.8 to about 98.4 mol % Z-1,1,1,4,4,4-hexafluoro-2-butene.

In some embodiments, the composition comprising neopentane and Z-1,1,1,4,4,4-hexafluoro-2-butene comprises from about 3.2 to about 1.6 mol % neopentane and about 96.8 to about 98.4 mol % Z-1,1,1,4,4,4-hexafluoro-2-butene. In some embodiments, the composition comprising neopentane and Z-1,1,1,4,4,4-hexafluoro-2-butene comprises from about 3.2 to about 1.6 mol % neopentane and about 96.8 to about 98.4 mol % Z-1,1,1,4,4,4-hexafluoro-2-butene, and has a boiling point of from about 32.6° C. to about 33.0° C. at a pressure of about 1 atm.

In some embodiments, the composition comprising neopentane and Z-1,1,1,4,4,4-hexafluoro-2-butene comprises:
from about 99.8 to about 85.2 mol % neopentane and about 0.2 to about 14.8 mol % Z-1,1,1,4,4,4-hexafluoro-2-butene; or
from about 99.8 to about 80.8 mol % neopentane and about 0.2 to about 19.2 mol % Z-1,1,1,4,4,4-hexafluoro-2-butene; or
from about 99.8 to about 76.2 mol % neopentane and about 0.2 to about 23.8 mol % Z-1,1,1,4,4,4-hexafluoro-2-butene; or
from about 99.8 to about 61.8 mol % neopentane and about 0.2 to about 38.2 mol % Z-1,1,1,4,4,4-hexafluoro-2-butene; or
from about 0.4 to about 0.2 mol % neopentane and about 99.6 to about 99.8 mol % Z-1,1,1,4,4,4-hexafluoro-2-butene; or
from about 99.8 to about 69.8 mol % neopentane and about 0.2 to about 30.2 mol % Z-1,1,1,4,4,4-hexafluoro-2-butene; or
from about 99.8 to about 67.6 mol % neopentane and about 0.2 to about 32.4 mol % Z-1,1,1,4,4,4-hexafluoro-2-butene; or
from about 99.8 to about 95.0 mol % neopentane and about 0.2 to about 5 mol % Z-1,1,1,4,4,4-hexafluoro-2-butene; or
from about 86.4 to about 63.6 mol % neopentane and about 13.6 to about 36.4 mol % Z-1,1,1,4,4,4-hexafluoro-2-butene; or
from about 0.4 to about 0.2 mol % neopentane and about 99.6 to about 99.8 mol % Z-1,1,1,4,4,4-hexafluoro-2-butene; or
from about 99.8 to about 96.6 mol % neopentane and about 0.2 to about 3.4 mol % Z-1,1,1,4,4,4-hexafluoro-2-butene; or
from about 80.6 to about 59.6 mol % neopentane and about 19.4 to about 40.4 mol % Z-1,1,1,4,4,4-hexafluoro-2-butene; or
from about 99.8 to about 97.6 mol % neopentane and about 0.2 to about 2.4 mol % Z-1,1,1,4,4,4-hexafluoro-2-butene; or
from about 74.2 to about 56.0 mol % neopentane and about 25.8 to about 44.0 mol % Z-1,1,1,4,4,4-hexafluoro-2-butene; or
from about 0.2 to about 0.8 mol % neopentane and about 99.2 to about 99.8 mol % Z-1,1,1,4,4,4-hexafluoro-2-butene; or
from about 99.8 to about 98.2 mol % neopentane and about 0.2 to about 1.8 mol % Z-1,1,1,4,4,4-hexafluoro-2-butene; or
from about 76.6 to about 50.0 mol % neopentane and about 23.4 to about 50.0 mol % Z-1,1,1,4,4,4-hexafluoro-2-butene; or
from about 1.0 to about 0.2 mol % neopentane and about 99.0 to about 99.8 mol % Z-1,1,1,4,4,4-hexafluoro-2-butene.

In some embodiments, the composition comprising neopentane and Z-1,1,1,4,4,4-hexafluoro-2-butene comprises:
from about 99.8 to about 85.2 mol % neopentane and about 0.2 to about 14.8 mol % Z-1,1,1,4,4,4-hexafluoro-2-butene; or
from about 99.8 to about 80.8 mol % neopentane and about 0.2 to about 19.2 mol % Z-1,1,1,4,4,4-hexafluoro-2-butene; or
from about 99.8 to about 76.2 mol % neopentane and about 0.2 to about 23.8 mol % Z-1,1,1,4,4,4-hexafluoro-2-butene; or
from about 99.8 to about 61.8 mol % neopentane and about 0.2 to about 38.2 mol % Z-1,1,1,4,4,4-hexafluoro-2-butene; or
from about 0.4 to about 0.2 mol % neopentane and about 99.6 to about 99.8 mol % Z-1,1,1,4,4,4-hexafluoro-2-butene; or
from about 99.8 to about 69.8 mol % neopentane and about 0.2 to about 30.2 mol % Z-1,1,1,4,4,4-hexafluoro-2-butene; or
from about 99.8 to about 67.6 mol % neopentane and about 0.2 to about 32.4 mol % Z-1,1,1,4,4,4-hexafluoro-2-butene; or
from about 99.8 to about 95.0 mol % neopentane and about 0.2 to about 5 mol % Z-1,1,1,4,4,4-hexafluoro-2-butene; or
from about 86.4 to about 63.6 mol % neopentane and about 13.6 to about 36.4 mol % Z-1,1,1,4,4,4-hexafluoro-2-butene; or
from about 0.4 to about 0.2 mol % neopentane and about 99.6 to about 99.8 mol % Z-1,1,1,4,4,4-hexafluoro-2-butene; or
from about 99.8 to about 96.6 mol % neopentane and about 0.2 to about 3.4 mol % Z-1,1,1,4,4,4-hexafluoro-2-butene; or
from about 80.6 to about 59.6 mol % neopentane and about 19.4 to about 40.4 mol % Z-1,1,1,4,4,4-hexafluoro-2-butene; or
from about 99.8 to about 97.6 mol % neopentane and about 0.2 to about 2.4 mol % Z-1,1,1,4,4,4-hexafluoro-2-butene; or
from about 74.2 to about 56.0 mol % neopentane and about 25.8 to about 44.0 mol % Z-1,1,1,4,4,4-hexafluoro-2-butene; or
from about 0.2 to about 0.8 mol % neopentane and about 99.2 to about 99.8 mol % Z-1,1,1,4,4,4-hexafluoro-2-butene; or
from about 99.8 to about 98.2 mol % neopentane and about 0.2 to about 1.8 mol % Z-1,1,1,4,4,4-hexafluoro-2-butene; or
from about 76.6 to about 50.0 mol % neopentane and about 23.4 to about 50.0 mol % Z-1,1,1,4,4,4-hexafluoro-2-butene; or
from about 1.0 to about 0.2 mol % neopentane and about 99.0 to about 99.8 mol % Z-1,1,1,4,4,4-hexafluoro-2-butene;
wherein the composition has a boiling point of from about −40° C. to about 120° C. at a pressure of about 1 atm, for example, wherein the composition has a boiling point of from about −40° C. to about 120° C. at a pressure of about 1 atm, for example, about −40° C. to about 100° C., about −40° C. to about 80° C., about −40° C. to about 60° C., about −40° C. to about 40° C., about −40° C. to about 20° C., about −40° C. to about 0° C., about −40° C. to about −20° C., about −20° C. to about 120° C., about −20° C. to about 100° C., about −20° C. to about 80° C., about −20° C. to about 60° C., about −20° C. to about 40° C., about −20° C. to about 20° C., about −20° C. to about 0° C., about 0° C. to about 120° C., about 0° C. to about 100° C., about 0° C. to about 80° C., about 0° C. to about 60° C., about 0° C. to about 40° C., about 0° C. to about 20° C., about 20° C. to about 120° C., about 20° C. to about 100° C., about 20° C. to about 80° C., about 20° C. to about 60° C., about 20° C. to about 40° C., about 40° C. to about 120° C., about 40° C. to about 100° C., about 40° C. to about 80° C., about 40° C. to about 60° C., about 60° C. to about 120° C., about 60° C. to about 100° C., about 60° C. to about 80° C., about 80° C. to about 120° C., about 80° C. to about 100° C., or about 100° C. to about 120° C.

In some embodiments, the composition comprising neopentane and Z-1,1,1,4,4,4-hexafluoro-2-butene has a boiling point of about −40° C. at a pressure of about 1 atm.

In some embodiments, the composition comprising neopentane and Z-1,1,1,4,4,4-hexafluoro-2-butene has a boiling point of about −20° C. at a pressure of about 1 atm.

In some embodiments, the composition comprising neopentane and Z-1,1,1,4,4,4-hexafluoro-2-butene has a boiling point of about 0° C. at a pressure of about 1 atm.

In some embodiments, the composition comprising neopentane and Z-1,1,1,4,4,4-hexafluoro-2-butene has a boiling point of about 20° C. at a pressure of about 1 atm.

In some embodiments, the composition comprising neopentane and Z-1,1,1,4,4,4-hexafluoro-2-butene has a boiling point of about 30° C. at a pressure of about 1 atm.

In some embodiments, the composition comprising neopentane and Z-1,1,1,4,4,4-hexafluoro-2-butene has a boiling point of about 40° C. at a pressure of about 1 atm.

In some embodiments, the composition comprising neopentane and Z-1,1,1,4,4,4-hexafluoro-2-butene has a boiling point of about 60° C. at a pressure of about 1 atm.

In some embodiments, the composition comprising neopentane and Z-1,1,1,4,4,4-hexafluoro-2-butene has a boiling point of about 80° C. at a pressure of about 1 atm.

In some embodiments, the composition comprising neopentane and Z-1,1,1,4,4,4-hexafluoro-2-butene has a boiling point of about 100° C. at a pressure of about 1 atm.

In some embodiments, the composition comprising neopentane and Z-1,1,1,4,4,4-hexafluoro-2-butene has a boiling point of about 120° C. at a pressure of about 1 atm.

In some embodiments, the compositions provided herein further comprise one or more additional components (i.e., additives). In some embodiments, the one or more additional components are each independently selected from the group consisting of a lubricant, a pour point modifier, an anti-foam agent, a viscosity improver, an emulsifier, a dispersant, an oxidation inhibitor, an extreme pressure agent, a corrosion inhibitor, a detergent, a catalyst, a surfactant, a flame retardant, a preservative, a colorant, an antioxidant, a reinforcing agent, a filler, an antistatic agent, a solubilizing agents, an IR attenuating agent, a nucleating agent, a cell controlling agent, an extrusion aid, a stabilizing agent, a thermally insulating agent, a plasticizer, a viscosity modifier, an impact modifier, a gas barrier resin, a polymer modifier, a rheology modifier, an antibacterial agent, a vapor pressure modifier, a UV absorber, a cross-linking agent, a permeability modifier, a bitterant, a propellant, an acid catcher, or any mixture thereof.

### Methods of Use

The inventive compositions can be used in a wide range of applications, including, but not limited to, use as aerosol propellants, refrigerants, and heat transfer media.

### Uses as a Heat Transfer Medium

The compositions provided herein can act as a working fluid used to carry heat from a heat source to a heat sink. Such heat transfer compositions may also be useful as a refrigerant in a cycle wherein the fluid undergoes a phase change; that is, from a liquid to a gas and back, or vice versa.

Exemplary heat transfer systems include, but are not limited to, air conditioners, freezers, refrigerators, heat pumps, water chillers, flooded evaporator chillers, direct expansion chillers, walk-in coolers, heat pumps, mobile refrigerators, mobile air conditioning units, and combinations thereof.

In some embodiments, the compositions provided herein may be useful in mobile heat transfer systems, including refrigeration, air conditioning, or heat pump systems or apparatus. In some embodiments, the compositions provided herein may be useful in stationary heat transfer systems, including refrigeration, air conditioning, or heat pump systems or apparatus.

As used herein, the term “mobile heat transfer system” refers to any refrigeration, air conditioner, or heating apparatus incorporated into a transportation unit for the road, rail, sea or air. In addition, mobile refrigeration or air conditioner units include those apparatus that are independent of any moving carrier and are known as “intermodal” systems. Such intermodal systems include “containers’ (combined sea/land transport) as well as “swap bodies” (combined road/rail transport).

As used herein, the term “stationary heat transfer system” refers to a system that is fixed in place during operation. A stationary heat transfer system may be located within or attached to a building, or may be a stand-alone device located out of doors, such as a soft drink vending machine. Such a stationary application may be a stationary air conditioning device or heat pump, including but not limited to, a chiller, a high temperature heat pumps, which may be a trans-critical heat pump (e.g., one that operates with a condenser temperature above 50° C., 70° C., 80° C., 100° C., 120° C., 140° C., 160° C., 180° C., or 200° C.), a residential, commercial or industrial air conditioning system, and may be window-mounted, ductless, ducted, packaged terminal, a chiller, and one that is exterior but connected to a building, such as a rooftop system. In stationary refrigeration applications, the compositions provided herein may be useful in high temperature, medium temperature and/or low temperature refrigeration equipment including commercial, industrial or residential refrigerators and freezers, ice machines, self-contained coolers and freezers, flooded evaporator chillers, direct expansion chillers, walk-in and reach-in coolers and freezers, and combination systems. In some embodiments, the compositions provided herein may be used in supermarket refrigerator systems.

In some embodiments, the compositions provided herein may be useful in methods for producing cooling, producing heating, and transferring heat.

In some embodiments, the present application provides a method for producing cooling, comprising evaporating a composition provided herein in the vicinity of a body to be cooled, and thereafter condensing said composition.

In some embodiments, the present application provides a method for producing heating, comprising condensing a composition provided herein in the vicinity of a body to be heated, and thereafter evaporating said compositions.

In some embodiments, the present application provides a method of using a composition provided herein as a heat transfer fluid composition. In some embodiments, the method comprises transporting said composition from a heat source to a heat sink.

Any of the compositions provided herein may be useful as a replacement for a currently used (“incumbent”) refrigerant, including, but not limited to, R-123 (or HFC-123, 2,2-dichloro-1,1,1-trifluoroethane), R-11 (or CFC-11, trichlorofluoromethane), R-12 (or CFC-12, dichlorodifluoromethane), R-22 (chlorodifluoromethane), R-245fa (or HFC-245fa, 1,1,1,3,3-pentafluoropropane), R-114 (or CFC-114, 1,2-dichloro-1,1,2,2-tetrafluoroethane), R-236fa (or HFC-236fa, 1,1,1,3,3,3-hexafluoropropane), R-236ea (or HFC-236ea, 1,1,1,2,3,3-hexafluoropropane), and R-124 (or HCFC-124, 2-chloro-1,1,1,2-tetrafluoroethane), among others.

As used herein, the term “incumbent refrigerant” refers to the refrigerant for which the heat transfer system was designed to operate, or the refrigerant that is resident in the heat transfer system.

In some embodiments, the present application provides a method for operating a heat transfer system or for transferring heat that is designed to operate with an incumbent refrigerant by charging an empty system with a composition provided herein, or by substantially replacing said incumbent refrigerant with a composition provided herein.

As used herein, the term “substantially replacing” refers to allowing the incumbent refrigerant to drain from the system, or pumping the incumbent refrigerant from the system, and then charging the system with a composition of the present invention (i.e., a composition provided herein). The system may be flushed with one or more quantities of the replacement refrigerant before being charged. It shall be understood that some small quantity of the incumbent refrigerant may be present in the system after the system has been charged with the composition provided herein.

In some embodiments, the present application provides a method for recharging a heat transfer system comprising an incumbent refrigerant and a lubricant, said method comprising substantially removing the incumbent refrigerant from the heat transfer system while retaining a substantial portion of the lubricant in said system and introducing a composition provided herein to the heat transfer system. In some embodiments, the lubricant in the system is partially replaced.

In some embodiments, the compositions provided herein may be used to top-off a refrigerant charge in a chiller. For example, if a chiller using HCFC-123 has diminished performance due to leakage of refrigerant, the compositions provided herein may be added to bring performance back up to specification.

In some embodiments, a heat exchange system comprising a composition of the invention is provided, wherein said system is selected from the group consisting of air conditioners, freezers, refrigerators, heat pumps, water chillers, flooded evaporator chillers, direct expansion chillers, walk-in coolers, heat pumps, mobile refrigerators, mobile air conditioning units, and systems having combinations thereof. In some embodiments, the composition provided herein may be useful in secondary loop systems wherein these compositions serve as the primary refrigerant thus providing cooling to a secondary heat transfer fluid that thereby cools a remote location.

Each of a vapor-compression refrigeration system, an air conditioning system, and a heat pump system includes as components an evaporator, a compressor, a condenser, and an expansion device. A vapor-compression cycle re-uses refrigerant in multiple steps producing a cooling effect in one step and a heating effect in a different step. The cycle can be described simply as follows. Liquid refrigerant enters an evaporator through an expansion device, and the liquid refrigerant boils in the evaporator, by withdrawing heat from the environment, at a low temperature to form a vapor and produce cooling. The low-pressure vapor enters a compressor where the vapor is compressed to raise its pressure and temperature. The higher-pressure (compressed) vapor refrigerant then enters the condenser in which the refrigerant condenses and discharges its heat to the environment. The refrigerant returns to the expansion device through which the liquid expands from the higher-pressure level in the condenser to the low-pressure level in the evaporator, thus repeating the cycle.

In some embodiments, the present application provides a heat transfer system comprising a composition provided herein. In some embodiments, the present application provides a refrigeration, air-conditioning, or heat pump apparatus comprising a composition provided herein. In some embodiments, the present application provides a stationary refrigeration or air-conditioning apparatus comprising a composition provided herein. In some embodiments, the present application provides a mobile refrigeration or air conditioning apparatus comprising a composition provided herein.

### Propellants

In some embodiments, the present application provides a composition as described herein for use as a propellant (e.g., in a sprayable composition). In some embodiments, the present application provides a sprayable composition comprising a composition provided herein. In some embodiments, the active ingredient to be sprayed together with inert ingredients, solvents, and other materials may also be present in the sprayable composition. In some embodiments, the sprayable composition is an aerosol. Suitable active materials to be sprayed include, but are not limited to, cosmetic materials, such as deodorants, perfumes, hair sprays, cleaners, and polishing agents, as well as medicinal materials such as anti-asthma and anti-halitosis medications.

In some embodiments, the present application provides a process for producing aerosol products. In some embodiments, the process comprises the step of adding a composition provided herein to one or more active ingredients in an aerosol container, wherein said composition functions as a propellant.

### EXAMPLES

The invention will be described in greater detail by way of specific examples. The following examples are offered for illustrative purposes, and are not intended to limit the invention in any manner. Those of skill in the art will readily recognize a variety of non-critical parameters which can be changed or modified to yield essentially the same results.

### Example 1. Compositions of E-HFO-1336mzz and Neopentane

The binary system of E-HFO-1336mzz/neopentane was explored for potential azeotropic and near-azeotropic behavior. To determine the relative volatility of this binary system, the PTx method as described herein was used. The pressure in a PTx cell of known volume was measured at constant temperature of 29.88° C. for various binary compositions. The collected experimental data are displayed in Table 1 below, where X2=liquid mole fraction of E-HFO-1336mzz; Y2=vapor mole fraction of E-HFO-1336mzz; Pexp=experimentally measured pressure; and Pcalc=pressure as calculated by NRTL model.

TABLE 1

| X2 | Y2 | psia, expt | psia, calc | (pcalc/pexp)-1 |
|---|---|---|---|---|
| 0 | 0 | 28.95 | — | — |
| 0.00365 | 0.01299 | 29.27 | 29.2493 | −7.07E−04 |
| 0.00843 | 0.02925 | 29.67 | 29.6307 | −1.32E−03 |
| 0.01809 | 0.05972 | 30.41 | 30.3664 | −1.43E−03 |
| 0.06643 | 0.17653 | 33.42 | 33.4348 | 4.43E−04 |
| 0.14533 | 0.29412 | 36.81 | 36.8276 | 4.79E−04 |
| 0.24612 | 0.38547 | 39.39 | 39.3919 | 4.76E−05 |
| 0.34667 | 0.44894 | 40.83 | 40.8352 | 1.27E−04 |
| 0.44829 | 0.50201 | 41.62 | 41.6126 | −1.78E−04 |
| 0.56542 | 0.56068 | 41.87 | 41.8789 | 2.12E−04 |
| 0.65475 | 0.60949 | 41.63 | 41.6328 | 6.73E−05 |
| 0.75779 | 0.67766 | 40.75 | 40.7363 | −3.36E−04 |
| 0.85193 | 0.7619 | 39.11 | 39.0868 | −5.94E−04 |
| 0.9333 | 0.86793 | 36.67 | 36.6737 | 1.02E−04 |
| 0.97972 | 0.95357 | 34.66 | 34.6996 | 1.14E−03 |
| 0.99014 | 0.97659 | 34.14 | 34.1806 | 1.19E−03 |
| 0.99356 | 0.98453 | 33.96 | 34.0032 | 1.27E−03 |
| 1 | 1 | 33.66 | — | — |

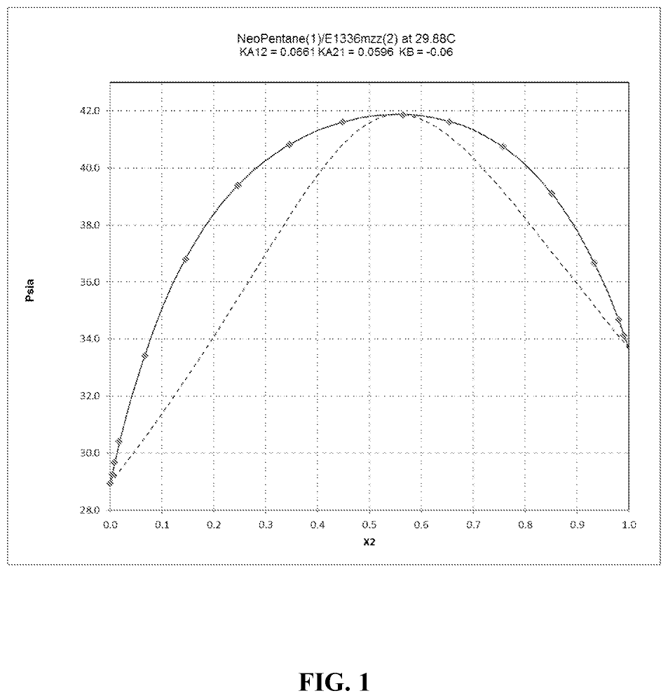

FIG. 1 displays a plot of the pressure vs composition data over the compositional range of 0-1 liquid mole fraction of E-HFO-1336mzz. The top curve of FIG. 1 represents the bubble point (“BP”) locus, and the bottom curve of FIG. 1 represents the dew point (“DP”) locus. FIG. 1 demonstrates the formation of an azeotrope at 29.88° C., of composition 0.552 mole fraction E-1,1,1,4,4,4-hexafluoro-2-butene and 0.448 mole fraction neopentane, as evidenced by the maximum in the Px diagram at a pressure of 41.8 psia.

Based on these VLE data, interaction coefficients were extracted. The NRTL model was run over the temperature range of −40 to 120° C. in increments of 10° C., allowing pressure to vary such that the azeotropic condition (X₂=Y₂) was met. The resulting predictions of azeotropes in the E-HFO-1336mzz/neopentane system are displayed in Table 2.

TABLE 2

| | Azeotrope | E-HFO-1336mzz | Neopentane |
|---|---|---|---|
| Temp | Pressure | Vapor | Vapor |
| (° C.) | (psi) | Mole Fraction | Mole Fraction |
| −40 | 2.0 | 0.40865 | 0.59135 |
| −30 | 3.5 | 0.43624 | 0.56376 |
| −20 | 5.9 | 0.46123 | 0.53877 |
| −10 | 9.3 | 0.48380 | 0.51620 |
| 0 | 14.1 | 0.50411 | 0.49589 |
| 10 | 20.9 | 0.52229 | 0.47771 |
| 20 | 30.0 | 0.53845 | 0.46155 |
| 30 | 41.9 | 0.55266 | 0.44734 |
| 40 | 57.4 | 0.56495 | 0.43505 |
| 50 | 77.0 | 0.57528 | 0.42472 |
| 60 | 101.7 | 0.58353 | 0.41647 |
| 70 | 132.5 | 0.58945 | 0.41055 |
| 80 | 171.2 | 0.59246 | 0.40754 |
| 90 | 220.8 | 0.59081 | 0.40919 |
| 100 | 278.1 | 0.58257 | 0.41744 |
| 110 | 331.2 | 0.57921 | 0.42079 |
| 120 | 389.6 | 0.57392 | 0.42608 |

The NRTL model was used to predict azeotropes over a pressure range of 1-30 atm at 1 atm increments, the results of which are displayed in Table 3.

TABLE 3

| | Azeotrope | Vapor | Vapor |
|---|---|---|---|
| Pressure | Temperature | Mole Fraction | Mole Fraction |
| (atm) | (° C.) | E-HFO-1336mzz | Neopentane |
| 1 | 0.9 | 0.5059 | 0.4941 |
| 2 | 19.4 | 0.5376 | 0.4624 |
| 3 | 31.6 | 0.5547 | 0.4453 |
| 4 | 40.8 | 0.5659 | 0.4341 |
| 5 | 48.4 | 0.5737 | 0.4263 |
| 6 | 54.8 | 0.5795 | 0.4205 |
| 7 | 60.4 | 0.5838 | 0.4162 |
| 8 | 65.4 | 0.5871 | 0.4129 |
| 9 | 69.9 | 0.5894 | 0.4106 |
| 10 | 74.0 | 0.5911 | 0.4089 |
| 11 | 77.7 | 0.5921 | 0.4079 |
| 12 | 81.2 | 0.5926 | 0.4074 |
| 13 | 84.3 | 0.5925 | 0.4075 |
| 14 | 87.2 | 0.5920 | 0.4080 |
| 15 | 89.9 | 0.5908 | 0.4092 |
| 16 | 92.4 | 0.5890 | 0.4110 |
| 17 | 94.6 | 0.5856 | 0.4144 |
| 18 | 97.3 | 0.5834 | 0.4166 |
| 19 | 100.2 | 0.5825 | 0.4175 |
| 20 | 103.1 | 0.5817 | 0.4183 |
| 21 | 105.9 | 0.5808 | 0.4192 |
| 22 | 108.6 | 0.5798 | 0.4202 |
| 23 | 111.2 | 0.5787 | 0.4213 |
| 24 | 113.8 | 0.5775 | 0.4225 |
| 25 | 116.3 | 0.5762 | 0.4238 |
| 26 | 118.8 | 0.5747 | 0.4253 |
| 27 | 121.2 | 0.5731 | 0.4269 |
| 28 | 123.5 | 0.5714 | 0.4286 |
| 29 | 125.8 | 0.5699 | 0.4301 |
| 30 | 128.0 | 0.5684 | 0.4316 |

The model was run over a temperature range from −40 to 120° C. in 20° C. increments, and also at 29.88° C. for the purpose of comparison to experimentally measured results. At each temperature, the model was run over the full range from 0 to 1 of E-HFO-1336mzz liquid molar composition in increments of 0.002. Thus the model was run at a total of 5010 combinations of temperature and E-HFO-1336mzz liquid molar composition (10 temperatures×501 compositions=5010 combinations). Table 4 shows representative results in increments of 0.10 E-HFO-1336mzz liquid molar composition, or the boundaries of near-azeotropic behavior.

TABLE 4

| | Liquid Mole | Vapor Mole | | | | | |
|---|---|---|---|---|---|---|---|
| | Fraction | Fraction | Liquid Mole | Vapor Mole | Bubble Point | Dew Point | [(BP- |
| Temp | E-HFO- | E-HFO- | Fraction | Fraction | Pressure | Pressure | DP)/BP]* |
| (° C.) | 1336mzz | 1336mzz | Neopentane | Neopentane | (psia) | (psia) | 100% |
| −40 | 0.000 | 0.0000 | 1.0000 | 1.0000 | 1.6172 | 1.6172 | 0.00% |
| −40 | 0.002 | 0.0071 | 0.9980 | 0.9929 | 1.6255 | 1.6196 | 0.37% |
| −40 | 0.018 | 0.0573 | 0.9820 | 0.9427 | 1.6864 | 1.6386 | 2.84% |
| −40 | 0.020 | 0.0629 | 0.9800 | 0.9371 | 1.6933 | 1.6409 | 3.09% |
| −40 | 0.038 | 0.1077 | 0.9620 | 0.8923 | 1.7499 | 1.6627 | 4.98% |
| −40 | 0.040 | 0.1121 | 0.9600 | 0.8879 | 1.7555 | 1.6651 | 5.15% |
| −40 | 0.230 | 0.3230 | 0.7700 | 0.6770 | 2.0094 | 1.9074 | 5.08% |
| −40 | 0.232 | 0.3242 | 0.7680 | 0.6758 | 2.0104 | 1.9099 | 5.00% |
| −40 | 0.282 | 0.3517 | 0.7180 | 0.6483 | 2.0309 | 1.9688 | 3.05% |
| −40 | 0.284 | 0.3527 | 0.7160 | 0.6473 | 2.0315 | 1.9710 | 2.98% |
| −40 | 0.300 | 0.3606 | 0.7000 | 0.6394 | 2.0361 | 1.9878 | 2.37% |
| −40 | 0.400 | 0.4050 | 0.6000 | 0.5950 | 2.0494 | 2.0490 | 0.02% |
| −40 | 0.500 | 0.4463 | 0.5000 | 0.5537 | 2.0410 | 2.0020 | 1.91% |
| −40 | 0.502 | 0.4472 | 0.4980 | 0.5528 | 2.0406 | 2.0001 | 1.99% |
| −40 | 0.524 | 0.4564 | 0.4760 | 0.5436 | 2.0359 | 1.9766 | 2.91% |
| −40 | 0.526 | 0.4573 | 0.4740 | 0.5427 | 2.0354 | 1.9743 | 3.00% |
| −40 | 0.528 | 0.4581 | 0.4720 | 0.5419 | 2.0349 | 1.9720 | 3.09% |
| −40 | 0.566 | 0.4747 | 0.4340 | 0.5253 | 2.0239 | 1.9241 | 4.93% |
| −40 | 0.568 | 0.4756 | 0.4320 | 0.5244 | 2.0232 | 1.9214 | 5.03% |
| −40 | 0.976 | 0.9109 | 0.0240 | 0.0891 | 1.4505 | 1.3774 | 5.04% |
| −40 | 0.978 | 0.9174 | 0.0220 | 0.0826 | 1.4429 | 1.3753 | 4.69% |
| −40 | 0.986 | 0.9450 | 0.0140 | 0.0550 | 1.4114 | 1.3667 | 3.17% |
| −40 | 0.988 | 0.9523 | 0.0120 | 0.0477 | 1.4033 | 1.3646 | 2.76% |
| −40 | 0.998 | 0.9916 | 0.0020 | 0.0084 | 1.3608 | 1.3541 | 0.50% |
| −40 | 1.000 | 1.0000 | 0.0000 | 0.0000 | 1.3520 | 1.3520 | 0.00% |
| −20 | 0.000 | 0.0000 | 1.0000 | 1.0000 | 4.4342 | 4.4342 | 0.00% |
| −20 | 0.002 | 0.0073 | 0.9980 | 0.9927 | 4.4582 | 4.4408 | 0.39% |
| −20 | 0.016 | 0.0533 | 0.9840 | 0.9467 | 4.6144 | 4.4873 | 2.76% |
| −20 | 0.018 | 0.0592 | 0.9820 | 0.9408 | 4.6352 | 4.4940 | 3.05% |
| −20 | 0.032 | 0.0973 | 0.9680 | 0.9027 | 4.7707 | 4.5412 | 4.81% |
| −20 | 0.034 | 0.1023 | 0.9660 | 0.8977 | 4.7888 | 4.5481 | 5.03% |
| −20 | 0.282 | 0.3758 | 0.7180 | 0.6242 | 5.7518 | 5.4616 | 5.05% |
| −20 | 0.284 | 0.3769 | 0.7160 | 0.6231 | 5.7544 | 5.4688 | 4.96% |
| −20 | 0.300 | 0.3856 | 0.7000 | 0.6144 | 5.7738 | 5.5252 | 4.31% |
| −20 | 0.332 | 0.4020 | 0.6680 | 0.5980 | 5.8056 | 5.6308 | 3.01% |
| −20 | 0.334 | 0.4030 | 0.6660 | 0.5970 | 5.8073 | 5.6370 | 2.93% |
| −20 | 0.400 | 0.4340 | 0.6000 | 0.5660 | 5.8469 | 5.8021 | 0.77% |
| −20 | 0.500 | 0.4784 | 0.5000 | 0.5216 | 5.8538 | 5.8357 | 0.31% |
| −20 | 0.592 | 0.5209 | 0.4080 | 0.4791 | 5.8059 | 5.6328 | 2.98% |
| −20 | 0.594 | 0.5219 | 0.4060 | 0.4781 | 5.8043 | 5.6267 | 3.06% |
| −20 | 0.600 | 0.5248 | 0.4000 | 0.4752 | 5.7991 | 5.6082 | 3.29% |
| −20 | 0.642 | 0.5464 | 0.3580 | 0.4536 | 5.7551 | 5.4677 | 4.99% |
| −20 | 0.644 | 0.5475 | 0.3560 | 0.4525 | 5.7527 | 5.4607 | 5.08% |
| −20 | 0.964 | 0.8941 | 0.0360 | 0.1059 | 4.5456 | 4.3150 | 5.07% |
| −20 | 0.966 | 0.8991 | 0.0340 | 0.1009 | 4.5285 | 4.3087 | 4.85% |
| −20 | 0.982 | 0.9425 | 0.0180 | 0.0575 | 4.3841 | 4.2584 | 2.87% |
| −20 | 0.998 | 0.9931 | 0.0020 | 0.0069 | 4.2241 | 4.2091 | 0.36% |
| −20 | 1.000 | 1.0000 | 0.0000 | 0.0000 | 4.2030 | 4.2030 | 0.00% |
| 0 | 0.000 | 0.0000 | 1.0000 | 1.0000 | 10.3222 | 10.3222 | 0.00% |
| 0 | 0.002 | 0.0073 | 0.9980 | 0.9927 | 10.3796 | 10.3379 | 0.40% |
| 0 | 0.016 | 0.0539 | 0.9840 | 0.9461 | 10.7565 | 10.4483 | 2.86% |
| 0 | 0.018 | 0.0600 | 0.9820 | 0.9400 | 10.8070 | 10.4642 | 3.17% |
| 0 | 0.030 | 0.0937 | 0.9700 | 0.9063 | 11.0938 | 10.5606 | 4.81% |
| 0 | 0.032 | 0.0989 | 0.9680 | 0.9011 | 11.1391 | 10.5768 | 5.05% |
| 0 | 0.322 | 0.4155 | 0.6780 | 0.5845 | 13.8866 | 13.1876 | 5.03% |
| 0 | 0.324 | 0.4166 | 0.6760 | 0.5834 | 13.8927 | 13.2051 | 4.95% |
| 0 | 0.370 | 0.4405 | 0.6300 | 0.5595 | 14.0094 | 13.5832 | 3.04% |
| 0 | 0.372 | 0.4415 | 0.6280 | 0.5585 | 14.0136 | 13.5983 | 2.96% |
| 0 | 0.400 | 0.4552 | 0.6000 | 0.5448 | 14.0645 | 13.7933 | 1.93% |
| 0 | 0.500 | 0.5022 | 0.5000 | 0.4978 | 14.1454 | 14.1449 | 0.00% |
| 0 | 0.600 | 0.5508 | 0.4000 | 0.4492 | 14.0751 | 13.8675 | 1.47% |
| 0 | 0.648 | 0.5764 | 0.3520 | 0.4236 | 13.9817 | 13.5701 | 2.94% |
| 0 | 0.650 | 0.5775 | 0.3500 | 0.4225 | 13.9768 | 13.5562 | 3.01% |
| 0 | 0.700 | 0.6073 | 0.3000 | 0.3927 | 13.8276 | 13.1823 | 4.67% |
| 0 | 0.710 | 0.6137 | 0.2900 | 0.3863 | 13.7907 | 13.1028 | 4.99% |
| 0 | 0.712 | 0.6150 | 0.2880 | 0.3850 | 13.7830 | 13.0868 | 5.05% |
| 0 | 0.948 | 0.8743 | 0.0520 | 0.1257 | 11.7385 | 11.1494 | 5.02% |
| 0 | 0.950 | 0.8782 | 0.0500 | 0.1218 | 11.7061 | 11.1339 | 4.89% |
| 0 | 0.972 | 0.9259 | 0.0280 | 0.0741 | 11.3228 | 10.9651 | 3.16% |
| 0 | 0.974 | 0.9306 | 0.0260 | 0.0694 | 11.2854 | 10.9499 | 2.97% |
| 0 | 0.998 | 0.9941 | 0.0020 | 0.0059 | 10.7988 | 10.7698 | 0.27% |
| 0 | 1.000 | 1.0000 | 0.0000 | 0.0000 | 10.7549 | 10.7549 | 0.00% |
| 20 | 0.000 | 0.0000 | 1.0000 | 1.0000 | 21.1399 | 21.1399 | 0.00% |
| 20 | 0.002 | 0.0073 | 0.9980 | 0.9927 | 21.2595 | 21.1727 | 0.41% |
| 20 | 0.016 | 0.0537 | 0.9840 | 0.9463 | 22.0503 | 21.4048 | 2.93% |
| 20 | 0.018 | 0.0598 | 0.9820 | 0.9402 | 22.1570 | 21.4382 | 3.24% |
| 20 | 0.030 | 0.0938 | 0.9700 | 0.9062 | 22.7665 | 21.6408 | 4.94% |
| 20 | 0.032 | 0.0990 | 0.9680 | 0.9010 | 22.8632 | 21.6748 | 5.20% |
| 20 | 0.352 | 0.4450 | 0.6480 | 0.5550 | 29.3816 | 27.8860 | 5.09% |
| 20 | 0.354 | 0.4461 | 0.6460 | 0.5539 | 29.3947 | 27.9239 | 5.00% |
| 20 | 0.400 | 0.4701 | 0.6000 | 0.5299 | 29.6494 | 28.7384 | 3.07% |
| 20 | 0.402 | 0.4711 | 0.5980 | 0.5289 | 29.6586 | 28.7708 | 2.99% |
| 20 | 0.500 | 0.5195 | 0.5000 | 0.4805 | 29.9403 | 29.8645 | 0.25% |
| 20 | 0.600 | 0.5700 | 0.4000 | 0.4300 | 29.9002 | 29.7282 | 0.58% |
| 20 | 0.698 | 0.6265 | 0.3020 | 0.3735 | 29.4990 | 28.6171 | 2.99% |
| 20 | 0.700 | 0.6278 | 0.3000 | 0.3722 | 29.4863 | 28.5883 | 3.05% |
| 20 | 0.776 | 0.6821 | 0.2240 | 0.3179 | 28.8389 | 27.3994 | 4.99% |
| 20 | 0.778 | 0.6838 | 0.2220 | 0.3162 | 28.8169 | 27.3663 | 5.03% |
| 20 | 0.922 | 0.8431 | 0.0780 | 0.1569 | 26.2733 | 24.9483 | 5.04% |
| 20 | 0.924 | 0.8462 | 0.0760 | 0.1538 | 26.2206 | 24.9152 | 4.98% |
| 20 | 0.964 | 0.9172 | 0.0360 | 0.0828 | 25.0275 | 24.2620 | 3.06% |
| 20 | 0.966 | 0.9213 | 0.0340 | 0.0787 | 24.9602 | 24.2297 | 2.93% |
| 20 | 0.998 | 0.9948 | 0.0020 | 0.0052 | 23.7709 | 23.7203 | 0.21% |
| 20 | 1.000 | 1.0000 | 0.0000 | 0.0000 | 23.6889 | 23.6889 | 0.00% |
| 29.88 | 0.000 | 0.0000 | 1.0000 | 1.0000 | 28.9758 | 28.9758 | 0.00% |
| 29.88 | 0.002 | 0.0072 | 0.9980 | 0.9928 | 29.1409 | 29.0215 | 0.41% |
| 29.88 | 0.016 | 0.0534 | 0.9840 | 0.9466 | 30.2362 | 29.3445 | 2.95% |
| 29.88 | 0.018 | 0.0595 | 0.9820 | 0.9405 | 30.3844 | 29.3912 | 3.27% |
| 29.88 | 0.030 | 0.0934 | 0.9700 | 0.9066 | 31.2334 | 29.6733 | 5.00% |
| 29.88 | 0.032 | 0.0986 | 0.9680 | 0.9014 | 31.3685 | 29.7208 | 5.25% |
| 29.88 | 0.366 | 0.4575 | 0.6340 | 0.5425 | 40.9262 | 38.8602 | 5.05% |
| 29.88 | 0.368 | 0.4586 | 0.6320 | 0.5414 | 40.9445 | 38.9135 | 4.96% |
| 29.88 | 0.370 | 0.4597 | 0.6300 | 0.5403 | 40.9626 | 38.9666 | 4.87% |
| 29.88 | 0.372 | 0.4608 | 0.6280 | 0.5392 | 40.9805 | 39.0194 | 4.79% |
| 29.88 | 0.374 | 0.4618 | 0.6260 | 0.5382 | 40.9981 | 39.0720 | 4.70% |
| 29.88 | 0.376 | 0.4629 | 0.6240 | 0.5371 | 41.0155 | 39.1243 | 4.61% |
| 29.88 | 0.378 | 0.4640 | 0.6220 | 0.5360 | 41.0327 | 39.1763 | 4.52% |
| 29.88 | 0.380 | 0.4650 | 0.6200 | 0.5350 | 41.0497 | 39.2280 | 4.44% |
| 29.88 | 0.382 | 0.4661 | 0.6180 | 0.5339 | 41.0664 | 39.2794 | 4.35% |
| 29.88 | 0.384 | 0.4672 | 0.6160 | 0.5328 | 41.0829 | 39.3305 | 4.27% |
| 29.88 | 0.386 | 0.4682 | 0.6140 | 0.5318 | 41.0992 | 39.3814 | 4.18% |
| 29.88 | 0.388 | 0.4693 | 0.6120 | 0.5307 | 41.1152 | 39.4319 | 4.09% |
| 29.88 | 0.390 | 0.4703 | 0.6100 | 0.5297 | 41.1311 | 39.4820 | 4.01% |
| 29.88 | 0.392 | 0.4714 | 0.6080 | 0.5286 | 41.1467 | 39.5319 | 3.92% |
| 29.88 | 0.394 | 0.4724 | 0.6060 | 0.5276 | 41.1621 | 39.5814 | 3.84% |
| 29.88 | 0.396 | 0.4735 | 0.6040 | 0.5265 | 41.1773 | 39.6305 | 3.76% |
| 29.88 | 0.398 | 0.4745 | 0.6020 | 0.5255 | 41.1922 | 39.6793 | 3.67% |
| 29.88 | 0.400 | 0.4756 | 0.6000 | 0.5244 | 41.2070 | 39.7278 | 3.59% |
| 29.88 | 0.414 | 0.4828 | 0.5860 | 0.5172 | 41.3043 | 40.0558 | 3.02% |
| 29.88 | 0.416 | 0.4838 | 0.5840 | 0.5162 | 41.3173 | 40.1010 | 2.94% |
| 29.88 | 0.500 | 0.5260 | 0.5000 | 0.4740 | 41.6894 | 41.4985 | 0.46% |
| 29.88 | 0.600 | 0.5774 | 0.4000 | 0.4226 | 41.6991 | 41.5591 | 0.34% |
| 29.88 | 0.700 | 0.6359 | 0.3000 | 0.3641 | 41.1831 | 40.1523 | 2.50% |
| 29.88 | 0.718 | 0.6478 | 0.2820 | 0.3522 | 41.0224 | 39.8037 | 2.97% |
| 29.88 | 0.720 | 0.6491 | 0.2800 | 0.3509 | 41.0031 | 39.7638 | 3.02% |
| 29.88 | 0.800 | 0.7104 | 0.2000 | 0.2896 | 39.9532 | 38.0322 | 4.81% |
| 29.88 | 0.812 | 0.7211 | 0.1880 | 0.2789 | 39.7420 | 37.7579 | 4.99% |
| 29.88 | 0.814 | 0.7229 | 0.1860 | 0.2771 | 39.7053 | 37.7120 | 5.02% |
| 29.88 | 0.902 | 0.8206 | 0.0980 | 0.1794 | 37.5605 | 35.6725 | 5.03% |
| 29.88 | 0.904 | 0.8233 | 0.0960 | 0.1767 | 37.4977 | 35.6263 | 4.99% |
| 29.88 | 0.960 | 0.9133 | 0.0400 | 0.0867 | 35.4128 | 34.3478 | 3.01% |
| 29.88 | 0.962 | 0.9171 | 0.0380 | 0.0829 | 35.3253 | 34.3028 | 2.89% |
| 29.88 | 0.998 | 0.9951 | 0.0020 | 0.0049 | 33.5673 | 33.5026 | 0.19% |
| 29.88 | 1.000 | 1.0000 | 0.0000 | 0.0000 | 33.4587 | 33.4587 | 0.00% |
| 40 | 0.000 | 0.0000 | 1.0000 | 1.0000 | 39.1175 | 39.1175 | 0.00% |
| 40 | 0.002 | 0.0071 | 0.9980 | 0.9929 | 39.3421 | 39.1803 | 0.41% |
| 40 | 0.016 | 0.0529 | 0.9840 | 0.9471 | 40.8366 | 39.6247 | 2.97% |
| 40 | 0.018 | 0.0590 | 0.9820 | 0.9410 | 41.0395 | 39.6889 | 3.29% |
| 40 | 0.028 | 0.0873 | 0.9720 | 0.9127 | 42.0165 | 40.0121 | 4.77% |
| 40 | 0.030 | 0.0927 | 0.9700 | 0.9073 | 42.2047 | 40.0772 | 5.04% |
| 40 | 0.378 | 0.4681 | 0.6220 | 0.5319 | 56.1782 | 53.3429 | 5.05% |
| 40 | 0.380 | 0.4692 | 0.6200 | 0.5308 | 56.2040 | 53.4172 | 4.96% |
| 40 | 0.400 | 0.4800 | 0.6000 | 0.5200 | 56.4444 | 54.1395 | 4.08% |
| 40 | 0.426 | 0.4936 | 0.5740 | 0.5064 | 56.7116 | 55.0067 | 3.01% |
| 40 | 0.428 | 0.4947 | 0.5720 | 0.5053 | 56.7301 | 55.0694 | 2.93% |
| 40 | 0.500 | 0.5315 | 0.5000 | 0.4685 | 57.2133 | 56.8210 | 0.69% |
| 40 | 0.600 | 0.5837 | 0.4000 | 0.4163 | 57.3115 | 57.2081 | 0.18% |
| 40 | 0.700 | 0.6429 | 0.3000 | 0.3571 | 56.6735 | 55.4940 | 2.08% |
| 40 | 0.736 | 0.6674 | 0.2640 | 0.3326 | 56.2229 | 54.5604 | 2.96% |
| 40 | 0.738 | 0.6688 | 0.2620 | 0.3312 | 56.1938 | 54.5054 | 3.00% |
| 40 | 0.740 | 0.6702 | 0.2600 | 0.3298 | 56.1644 | 54.4501 | 3.05% |
| 40 | 0.800 | 0.7176 | 0.2000 | 0.2824 | 55.0530 | 52.6872 | 4.30% |
| 40 | 0.900 | 0.8239 | 0.1000 | 0.1761 | 51.9480 | 49.5417 | 4.63% |
| 40 | 0.954 | 0.9060 | 0.0460 | 0.0940 | 49.3528 | 47.8448 | 3.06% |
| 40 | 0.956 | 0.9095 | 0.0440 | 0.0905 | 49.2407 | 47.7826 | 2.96% |
| 40 | 0.998 | 0.9953 | 0.0020 | 0.0047 | 46.5752 | 46.4927 | 0.18% |
| 40 | 1.000 | 1.0000 | 0.0000 | 0.0000 | 46.4321 | 46.4321 | 0.00% |
| 60 | 0.000 | 0.0000 | 1.0000 | 1.0000 | 66.7508 | 66.7508 | 0.00% |
| 60 | 0.002 | 0.0069 | 0.9980 | 0.9931 | 67.1411 | 66.8632 | 0.41% |
| 60 | 0.016 | 0.0516 | 0.9840 | 0.9484 | 69.7544 | 67.6585 | 3.00% |
| 60 | 0.018 | 0.0575 | 0.9820 | 0.9425 | 70.1115 | 67.7734 | 3.33% |
| 60 | 0.028 | 0.0854 | 0.9720 | 0.9146 | 71.8390 | 68.3526 | 4.85% |
| 60 | 0.030 | 0.0907 | 0.9700 | 0.9093 | 72.1732 | 68.4694 | 5.13% |
| 60 | 0.398 | 0.4842 | 0.6020 | 0.5158 | 99.4245 | 94.3842 | 5.07% |
| 60 | 0.400 | 0.4853 | 0.6000 | 0.5147 | 99.4736 | 94.5224 | 4.98% |
| 60 | 0.444 | 0.5092 | 0.5560 | 0.4908 | 100.4082 | 97.3428 | 3.05% |
| 60 | 0.446 | 0.5102 | 0.5540 | 0.4898 | 100.4443 | 97.4591 | 2.97% |
| 60 | 0.500 | 0.5388 | 0.5000 | 0.4612 | 101.2191 | 100.0780 | 1.13% |
| 60 | 0.600 | 0.5927 | 0.4000 | 0.4073 | 101.6574 | 101.6166 | 0.04% |
| 60 | 0.700 | 0.6531 | 0.3000 | 0.3469 | 100.6874 | 99.1097 | 1.57% |
| 60 | 0.764 | 0.6989 | 0.2360 | 0.3011 | 99.1535 | 96.1892 | 2.99% |
| 60 | 0.766 | 0.7004 | 0.2340 | 0.2996 | 99.0919 | 96.0881 | 3.03% |
| 60 | 0.800 | 0.7284 | 0.2000 | 0.2716 | 97.9001 | 94.3058 | 3.67% |
| 60 | 0.946 | 0.8988 | 0.0540 | 0.1012 | 88.7653 | 86.0797 | 3.03% |
| 60 | 0.948 | 0.9020 | 0.0520 | 0.0980 | 88.5816 | 85.9667 | 2.95% |
| 60 | 0.998 | 0.9956 | 0.0020 | 0.0044 | 83.3043 | 83.1736 | 0.16% |
| 60 | 1.000 | 1.0000 | 0.0000 | 0.0000 | 83.0634 | 83.0634 | 0.00% |
| 80 | 0.000 | 0.0000 | 1.0000 | 1.0000 | 106.7445 | 106.7445 | 0.00% |
| 80 | 0.002 | 0.0067 | 0.9980 | 0.9933 | 107.3858 | 106.9363 | 0.42% |
| 80 | 0.014 | 0.0441 | 0.9860 | 0.9559 | 111.1113 | 108.0998 | 2.71% |
| 80 | 0.016 | 0.0499 | 0.9840 | 0.9501 | 111.7122 | 108.2958 | 3.06% |
| 80 | 0.028 | 0.0828 | 0.9720 | 0.9172 | 115.2035 | 109.4849 | 4.96% |
| 80 | 0.030 | 0.0880 | 0.9700 | 0.9120 | 115.7668 | 109.6852 | 5.25% |
| 80 | 0.416 | 0.4950 | 0.5840 | 0.5050 | 167.0991 | 158.5962 | 5.09% |
| 80 | 0.418 | 0.4962 | 0.5820 | 0.5038 | 167.1918 | 158.8495 | 4.99% |
| 80 | 0.460 | 0.5194 | 0.5400 | 0.4806 | 168.8860 | 163.7680 | 3.03% |
| 80 | 0.462 | 0.5205 | 0.5380 | 0.4795 | 168.9549 | 163.9796 | 2.94% |
| 80 | 0.500 | 0.5412 | 0.5000 | 0.4588 | 170.0653 | 167.5014 | 1.51% |
| 80 | 0.600 | 0.5968 | 0.4000 | 0.4032 | 171.1919 | 171.1762 | 0.01% |
| 80 | 0.700 | 0.6587 | 0.3000 | 0.3413 | 169.5099 | 167.0483 | 1.45% |
| 80 | 0.768 | 0.7084 | 0.2320 | 0.2916 | 166.4468 | 161.4755 | 2.99% |
| 80 | 0.770 | 0.7100 | 0.2300 | 0.2900 | 166.3295 | 161.2920 | 3.03% |
| 80 | 0.800 | 0.7350 | 0.2000 | 0.2650 | 164.3623 | 158.4508 | 3.60% |
| 80 | 0.900 | 0.8391 | 0.1000 | 0.1609 | 154.5696 | 148.3564 | 4.02% |
| 80 | 0.944 | 0.9001 | 0.0560 | 0.0999 | 148.3449 | 143.8749 | 3.01% |
| 80 | 0.946 | 0.9032 | 0.0540 | 0.0968 | 148.0292 | 143.6728 | 2.94% |
| 80 | 0.998 | 0.9959 | 0.0020 | 0.0041 | 138.7018 | 138.4930 | 0.15% |
| 80 | 1.000 | 1.0000 | 0.0000 | 0.0000 | 138.2971 | 138.2971 | 0.00% |
| 100 | 0.000 | 0.0000 | 1.0000 | 1.0000 | 162.0606 | 162.0606 | 0.00% |
| 100 | 0.002 | 0.0063 | 0.9980 | 0.9937 | 163.0789 | 162.3803 | 0.43% |
| 100 | 0.014 | 0.0421 | 0.9860 | 0.9579 | 169.0432 | 164.3232 | 2.79% |
| 100 | 0.016 | 0.0477 | 0.9840 | 0.9523 | 170.0136 | 164.6512 | 3.15% |
| 100 | 0.026 | 0.0743 | 0.9740 | 0.9257 | 174.7674 | 166.3096 | 4.84% |
| 100 | 0.028 | 0.0793 | 0.9720 | 0.9207 | 175.6990 | 166.6450 | 5.15% |
| 100 | 0.400 | 0.4784 | 0.6000 | 0.5216 | 270.4013 | 256.5804 | 5.11% |
| 100 | 0.402 | 0.4796 | 0.5980 | 0.5204 | 270.5470 | 257.2455 | 4.92% |
| 100 | 0.438 | 0.5005 | 0.5620 | 0.4995 | 272.9099 | 264.6125 | 3.04% |
| 100 | 0.440 | 0.5016 | 0.5600 | 0.4984 | 273.0274 | 264.9359 | 2.96% |
| 100 | 0.500 | 0.5355 | 0.5000 | 0.4645 | 275.9366 | 272.8608 | 1.11% |
| 100 | 0.600 | 0.5928 | 0.4000 | 0.4072 | 278.2866 | 278.3577 | −0.03% |
| 100 | 0.700 | 0.6566 | 0.3000 | 0.3434 | 277.3187 | 274.7297 | 0.93% |
| 100 | 0.756 | 0.6978 | 0.2440 | 0.3022 | 274.8945 | 266.7121 | 2.98% |
| 100 | 0.758 | 0.6994 | 0.2420 | 0.3006 | 274.7739 | 266.2803 | 3.09% |
| 100 | 0.794 | 0.7295 | 0.2060 | 0.2705 | 271.9438 | 258.5450 | 4.93% |
| 100 | 0.796 | 0.7312 | 0.2040 | 0.2688 | 271.7221 | 258.1176 | 5.01% |
| 100 | 0.888 | 0.8269 | 0.1120 | 0.1731 | 251.5621 | 238.9478 | 5.01% |
| 100 | 0.890 | 0.8293 | 0.1100 | 0.1707 | 251.0532 | 238.5452 | 4.98% |
| 100 | 0.952 | 0.9148 | 0.0480 | 0.0852 | 233.6140 | 226.4451 | 3.07% |
| 100 | 0.954 | 0.9180 | 0.0460 | 0.0820 | 232.9938 | 226.0677 | 2.97% |
| 100 | 0.998 | 0.9960 | 0.0020 | 0.0040 | 218.3357 | 217.9789 | 0.16% |
| 100 | 1.000 | 1.0000 | 0.0000 | 0.0000 | 217.6210 | 217.6210 | 0.00% |
| 120 | 0.000 | 0.0000 | 1.0000 | 1.0000 | 236.1168 | 236.1168 | 0.00% |
| 120 | 0.002 | 0.0060 | 0.9980 | 0.9940 | 237.7196 | 236.6528 | 0.45% |
| 120 | 0.004 | 0.0118 | 0.9960 | 0.9882 | 239.3178 | 237.1915 | 0.89% |
| 120 | 0.006 | 0.0175 | 0.9940 | 0.9825 | 240.9116 | 237.7328 | 1.32% |
| 120 | 0.008 | 0.0232 | 0.9920 | 0.9768 | 242.5012 | 238.2769 | 1.74% |
| 120 | 0.010 | 0.0288 | 0.9900 | 0.9712 | 244.0867 | 238.8236 | 2.16% |
| 120 | 0.012 | 0.0342 | 0.9880 | 0.9658 | 245.6682 | 239.3732 | 2.56% |
| 120 | 0.014 | 0.0396 | 0.9860 | 0.9604 | 247.2460 | 239.9254 | 2.96% |
| 120 | 0.016 | 0.0449 | 0.9840 | 0.9551 | 248.8201 | 240.4805 | 3.35% |
| 120 | 0.024 | 0.0651 | 0.9760 | 0.9349 | 255.0835 | 242.7293 | 4.84% |
| 120 | 0.026 | 0.0700 | 0.9740 | 0.9300 | 256.6420 | 243.2988 | 5.20% |
| 120 | 0.370 | 0.4533 | 0.6300 | 0.5467 | 374.6714 | 355.8479 | 5.02% |
| 120 | 0.372 | 0.4545 | 0.6280 | 0.5455 | 374.9127 | 356.3524 | 4.95% |
| 120 | 0.426 | 0.4874 | 0.5740 | 0.5126 | 380.6432 | 369.0815 | 3.04% |
| 120 | 0.428 | 0.4886 | 0.5720 | 0.5114 | 380.8278 | 369.5134 | 2.97% |
| 120 | 0.500 | 0.5307 | 0.5000 | 0.4693 | 386.2785 | 382.5140 | 0.97% |
| 120 | 0.600 | 0.5896 | 0.4000 | 0.4104 | 390.1957 | 390.4366 | −0.06% |
| 120 | 0.700 | 0.6549 | 0.3000 | 0.3451 | 389.6846 | 386.8445 | 0.73% |
| 120 | 0.800 | 0.7341 | 0.2000 | 0.2659 | 383.6353 | 375.4644 | 2.13% |
| 120 | 0.900 | 0.8404 | 0.1000 | 0.1596 | 369.4663 | 359.4971 | 2.70% |
| 120 | 0.962 | 0.9304 | 0.0380 | 0.0696 | 353.7368 | 343.1236 | 3.00% |
| 120 | 0.964 | 0.9337 | 0.0360 | 0.0663 | 353.0395 | 342.2334 | 3.06% |
| 120 | 0.966 | 0.9371 | 0.0340 | 0.0629 | 352.3105 | 341.3537 | 3.11% |
| 120 | 0.972 | 0.9475 | 0.0280 | 0.0525 | 349.7199 | 338.7722 | 3.13% |
| 120 | 0.974 | 0.9511 | 0.0260 | 0.0489 | 348.1987 | 337.9295 | 2.95% |
| 120 | 0.998 | 0.9960 | 0.0020 | 0.0040 | 329.1331 | 328.3877 | 0.23% |
| 120 | 1.000 | 1.0000 | 0.0000 | 0.0000 | 327.6335 | 327.6335 | 0.00% |

Near-azeotropes formed between E-HFO-1336mzz and neopentane at 1 atm are shown in Table 5. Table 5 shows representative data in increments of 0.10 E-HFO-1336mzz liquid molar composition, or the boundaries of near-azeotropic behavior.

TABLE 5

| | | Liquid Mole | Vapor Mole | | | | | |
|---|---|---|---|---|---|---|---|---|
| | | Fraction | Fraction | Liquid Mole | Liquid Mole | Bubble Point | Dew Point | [(BP- |
| Pressure | Temp | E-HFO- | E-HFO- | Fraction | Fraction | Pressure | Pressure | DP)/BP]* |
| (atm) | (° C.) | 1336mzz | 1336mzz | Neopentane | Neopentane | (psia) | (psia) | 100% |
| 1.00 | 9.461 | 0 | 0 | 1 | 1 | 14.69595 | 14.69595 | 0.00% |
| 1.00 | 9.305 | 0.002 | 0.01 | 1.00 | 0.993 | 14.696 | 14.636 | 0.41% |
| 1.00 | 8.308 | 0.016 | 0.05 | 0.98 | 0.946 | 14.696 | 14.270 | 2.90% |
| 1.00 | 8.177 | 0.018 | 0.06 | 0.98 | 0.940 | 14.696 | 14.225 | 3.21% |
| 1.00 | 7.449 | 0.03 | 0.0938898 | 0.97 | 0.9061102 | 14.69595 | 13.98093 | 4.87% |
| 1.00 | 7.336 | 0.032 | 0.0991343 | 0.968 | 0.9008656 | 14.69595 | 13.94488 | 5.11% |
| 1.00 | 1.409 | 0.324 | 0.4177095 | 0.676 | 0.5822905 | 14.69595 | 13.95334 | 5.05% |
| 1.00 | 1.195 | 0.37 | 0.4414781 | 0.63 | 0.5585219 | 14.69595 | 14.23698 | 3.12% |
| 1.00 | 1.187 | 0.372 | 0.4424725 | 0.628 | 0.5575275 | 14.69595 | 14.24871 | 3.04% |
| 1.00 | 1.180 | 0.374 | 0.4434643 | 0.626 | 0.5565357 | 14.69595 | 14.26035 | 2.96% |
| 1.00 | 1.094 | 0.4 | 0.4561451 | 0.6 | 0.5438549 | 14.69595 | 14.40299 | 1.99% |
| 1.00 | 0.946 | 0.5 | 0.5031367 | 0.5 | 0.4968633 | 14.69595 | 14.695 | 0.01% |
| 1.00 | 1.065 | 0.6 | 0.5519321 | 0.4 | 0.4480679 | 14.69595 | 14.48902 | 1.41% |
| 1.00 | 1.244 | 0.652 | 0.5800897 | 0.348 | 0.4199103 | 14.69595 | 14.2598 | 2.97% |
| 1.00 | 1.252 | 0.654 | 0.5812312 | 0.346 | 0.4187688 | 14.69595 | 14.25034 | 3.03% |
| 1.00 | 1.589 | 0.714 | 0.6181589 | 0.286 | 0.3818411 | 14.69595 | 13.96853 | 4.95% |
| 1.00 | 1.603 | 0.716 | 0.6194943 | 0.284 | 0.3805057 | 14.69595 | 13.95961 | 5.01% |
| 1.00 | 5.262 | 0.942 | 0.8666191 | 0.058 | 0.1333809 | 14.69595 | 13.95456 | 5.04% |
| 1.00 | 5.325 | 0.944 | 0.8703764 | 0.056 | 0.1296236 | 14.69595 | 13.97141 | 4.93% |
| 1.00 | 6.231 | 0.97 | 0.9241145 | 0.03 | 0.0758854 | 14.69595 | 14.24138 | 3.09% |
| 1.00 | 6.308 | 0.972 | 0.9286651 | 0.028 | 0.0713348 | 14.69595 | 14.26647 | 2.92% |
| 1.00 | 7.418184 | 0.998 | 0.9943818 | 0.002 | 0.00561824 | 14.69595 | 14.65994 | 0.25% |
| 1.00 | 7.512796 | 1 | 1 | 0 | 0 | 14.69595 | 14.69595 | 0.00% |

The detailed data in Tables 4-5 are broadly summarized in Table 6 below. From the results in Table 5, azeotrope-like compositions with differences of 3% or less between bubble point pressures and dew point pressures exist from:
(1) 0.002 to 0.016 mole fraction E-1336mzz and from 0.984 to 0.998 mole percent neopentane at 1 atmosphere pressure boiling at from 8.31 to 9.31° C.;
(2) 0.374 to 0.652 mole fraction E-1336mzz and from 0.384 to 0.626 mole percent neopentane at 1 atmosphere pressure boiling at from 0.95 to 1.24° C.; and
(3) 0.972 to 0.998 mole fraction E-1336mzz and from 0.002 to 0.028 mole percent neopentane at 1 atmosphere pressure boiling at from 6.31 to 7.42° C.

Ranges of 3% azeotrope-like compositions (based on [(BP−VP)/BP]×100≤3) are listed in Table 6.

TABLE 6

| | | E-HFO-1336mzz Vapor |
|---|---|---|
| | Temp | Mole Percentage Range |
| Components | (° C.) | (Remainder Neopentane) |
| E-HFO-1336mzz/ | −40 | 0.002 to 0.018 and |
| Neopentane | | 0.284 to 0.524 and |
| | | 0.988 to 0.998 |
| E-HFO-1336mzz/ | −20 | 0.002 to 0.016 and |
| Neopentane | | 0.334 to 0.592 and |
| | | 0.982 to 0.998 |
| E-HFO-1336mzz/ | 0 | 0.002 to 0.016 and |
| Neopentane | | 0.372 to 0.648 and |
| | | 0.974 to 0.998 |
| E-HFO-1336mzz/ | 20 | 0.002 to 0.016 and |
| Neopentane | | 0.402 to 0.698 and |
| | | 0.966 to 0.998 |
| E-HFO-1336mzz/ | 29.88 | 0.002 to 0.016 and |
| Neopentane | | 0.416 to 0.718 and |
| | | 0.962 to 0.998 |
| E-HFO-1336mzz/ | 40 | 0.002 to 0.016 and |
| Neopentane | | 0.428 to 0.736 and |
| | | 0.956 to 0.998 |
| E-HFO-1336mzz/ | 60 | 0.002 to 0.016 and |
| Neopentane | | 0.446 to 0.764 and |
| | | 0.948 to 0.009 |
| E-HFO-1336mzz/ | 80 | 0.002 to 0.014 and |
| Neopentane | | 0.462 to 0.768 and |
| | | 0.946 to 0.998 |
| E-HFO-1336mzz/ | 100 | 0.002 to 0.014 and |
| Neopentane | | 0.440 to 0.756 and |
| | | 0.954 to 0.998 |
| E-HFO-1336mzz/ | 120 | 0.002 to 0.014 and |
| Neopentane | | 0.428 to 0.962 and |
| | | 0.974 to 0.998 |

### Example 2. Compositions of Z-HFO-1336mzz and Neopentane

The binary system of Z-HFO-1336mzz/neopentane was explored for potential azeotropic and near-azeotropic behavior. To determine the relative volatility of this binary system, the PTx method described herein was used. The pressure in a PTx cell of known volume was measured at constant temperature of 29.90° C. for various binary compositions. The collected experimental data are displayed in Table 7 below, where X₂=liquid mole fraction of neopentane; Y₂=vapor mole fraction of neopentane; Pₑₓₚ=experimentally measured pressure; and P_{calc}=pressure as calculated by NRTL model.

TABLE 7

| X2 | Y2 | psia, expt | psia, calc | (pcalc/pexp)-1 |
|---|---|---|---|---|
| 0 | 0 | 12.98 | — | — |
| 0.00565 | 0.04447 | 13.53 | 13.5319 | 1.38E−04 |
| 0.00915 | 0.06959 | 13.88 | 13.8641 | −1.14E−03 |
| 0.0182 | 0.12772 | 14.67 | 14.6968 | 1.83E−03 |
| 0.06537 | 0.32642 | 18.45 | 18.4289 | −1.15E−03 |
| 0.14432 | 0.48593 | 22.92 | 22.9065 | −5.87E−04 |
| 0.24575 | 0.58368 | 26.49 | 26.5246 | 1.31E−03 |
| 0.34458 | 0.63707 | 28.61 | 28.6679 | 2.02E−03 |
| 0.45163 | 0.67591 | 30.22 | 30.1073 | −3.73E−03 |
| 0.55029 | 0.70455 | 30.96 | 30.9557 | −1.38E−04 |
| 0.65079 | 0.73293 | 31.51 | 31.5177 | 2.45E−04 |
| 0.75045 | 0.76664 | 31.79 | 31.806 | 5.04E−04 |
| 0.8517 | 0.81802 | 31.66 | 31.6557 | −1.37E−04 |
| 0.93498 | 0.8925 | 30.77 | 30.7664 | −1.17E−04 |
| 0.98191 | 0.96298 | 29.6 | 29.6229 | 7.74E−04 |
| 0.99116 | 0.98103 | 29.26 | 29.3112 | 1.75E−03 |
| 0.99555 | 0.99022 | 29.1 | 29.1511 | 1.76E−03 |
| 1 | 1 | 28.98 | — | — |

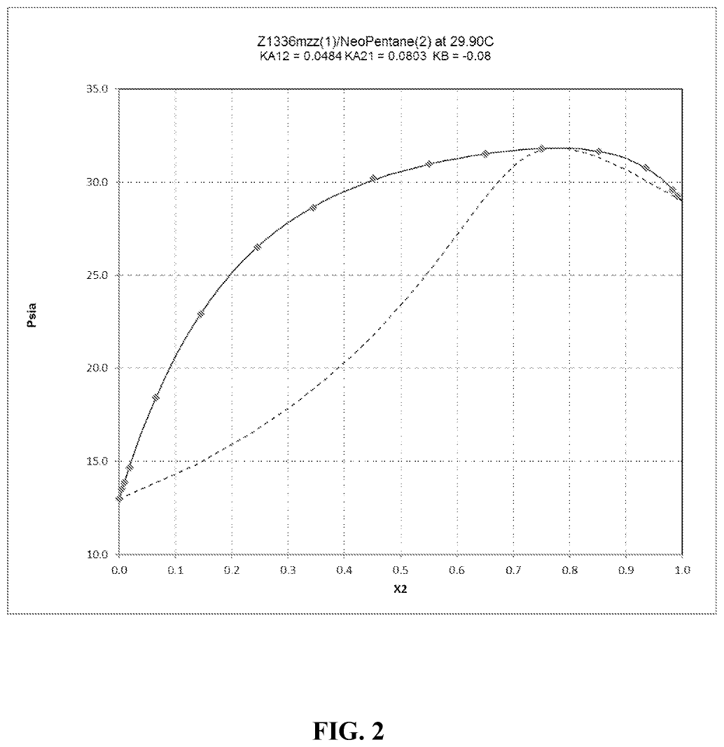

The vapor pressure vs. neopentane liquid mole fraction data shown in Table 7 are plotted in FIG. 2, with the experimental data points shown as solid points. The solid line represents bubble point predictions using the NRTL equation. The dashed line represents predicted dew points. FIG. 2 demonstrates the formation of an azeotrope at 29.90° C. of the composition containing 0.220 mole fraction Z-1,1,1,4,4,4-hexafluoro-2-butene and 0.780 mole fraction neopentane, as evidenced by the maximum in the Px diagram at a pressure of 31.8 psia.

Based on these VLE data, interaction coefficients were extracted. The NRTL model was run over the temperature range of −40 to 120° C. in increments of 10° C. allowing pressure to vary such that the azeotropic condition (X₂=Y₂) was met. The resulting predicted azeotropes in the Z-HFO-1336mzz/neopentane system, and the experimentally determined data at 29.90° C., are displayed in Table 8.

TABLE 8

| | Azeotrope | Vapor | Vapor |
|---|---|---|---|
| Temp | Pressure | Mole Fraction | Mole Fraction |
| (° C.) | (psi) | Z-HFO-1336mzz | Neopentane |
| −40 | 1.6 | 0.07883 | 0.92117 |
| −30 | 2.8 | 0.09995 | 0.90005 |
| −20 | 4.6 | 0.12089 | 0.87911 |
| −10 | 7.2 | 0.14154 | 0.85846 |
| 0 | 10.9 | 0.16187 | 0.83813 |
| 10 | 16.0 | 0.18187 | 0.81813 |
| 20 | 22.9 | 0.20154 | 0.79846 |
| 30 | 31.9 | 0.22092 | 0.77908 |
| 40 | 43.5 | 0.24008 | 0.75992 |
| 50 | 58.3 | 0.25908 | 0.74092 |
| 60 | 76.8 | 0.27803 | 0.72197 |
| 70 | 99.9 | 0.29709 | 0.70291 |
| 80 | 128.6 | 0.31656 | 0.68344 |
| 90 | 164.6 | 0.33709 | 0.66291 |
| 100 | 211.4 | 0.36145 | 0.63855 |
| 110 | 260.8 | 0.38626 | 0.61374 |
| 120 | 308.7 | 0.40156 | 0.59844 |

The model was used to predict azeotropes over a pressure range of 1-30 atm at 1 atm increments, the results of which are displayed in Table 9.

TABLE 9

| | Azeotrope | Vapor | Vapor |
|---|---|---|---|
| Pressure | Temperature | Mole Fraction | Mole Fraction |
| (atm) | (° C.) | Z-HFO-1336mzz | Neopentane |
| 1 | 7.7 | 0.17728 | 0.82272 |
| 2 | 27.5 | 0.21605 | 0.78395 |
| 3 | 40.4 | 0.24089 | 0.75911 |
| 4 | 50.3 | 0.25963 | 0.74037 |
| 5 | 58.3 | 0.27489 | 0.72511 |
| 6 | 65.2 | 0.28788 | 0.71212 |
| 7 | 71.1 | 0.29927 | 0.70073 |
| 8 | 76.4 | 0.30948 | 0.69052 |
| 9 | 81.1 | 0.31879 | 0.68121 |
| 10 | 85.4 | 0.32741 | 0.67259 |
| 11 | 89.3 | 0.33551 | 0.66449 |
| 12 | 92.8 | 0.34325 | 0.65675 |
| 13 | 96.0 | 0.35079 | 0.64921 |
| 14 | 98.9 | 0.35839 | 0.64161 |
| 15 | 101.6 | 0.36666 | 0.63334 |
| 16 | 104.3 | 0.37595 | 0.62405 |
| 17 | 107.6 | 0.38215 | 0.61785 |
| 18 | 110.8 | 0.38757 | 0.61243 |
| 19 | 114.0 | 0.39255 | 0.60745 |
| 20 | 117.0 | 0.39718 | 0.60282 |
| 21 | 120.0 | 0.40153 | 0.59847 |
| 22 | 122.9 | 0.40563 | 0.59437 |
| 23 | 125.7 | 0.40952 | 0.59048 |
| 24 | 128.4 | 0.41322 | 0.58678 |
| 25 | 131.0 | 0.41674 | 0.58326 |
| 26 | 133.6 | 0.42010 | 0.57990 |
| 27 | 136.1 | 0.42332 | 0.57668 |
| 28 | 138.5 | 0.42640 | 0.57360 |
| 29 | 140.9 | 0.42935 | 0.57065 |
| 30 | 143.2 | 0.43191 | 0.56809 |

The model was run over a temperature range from −40 to 120° C. in 20 deg. increments, and also at 29.90° C. for the purpose of comparison to experimentally measured results. At each temperature, the model was run over the full range from 0 to 1 of Z-HFO-1336mzz liquid molar composition in increments of 0.002. Thus the model was run at a total of 5010 combinations of temperature and Z-HFO-1336mzz liquid molar composition (10 temperatures×501 compositions=5010). Table 10 shows representative results in increments of 0.10 Z-HFO-1336mzz liquid molar composition, or the boundaries of near-azeotropic behavior.

TABLE 10

| | Liquid Mole | Vapor Mole | | | | | |
|---|---|---|---|---|---|---|---|
| Total | Fraction | Fraction | Liquid Mole | Vapor Mole | Bubble Point | Dew Point | [(BP- |
| Temp | Z-HFO- | Z-HFO- | Fraction | Fraction | Pressure | Pressure | DP)/BP]* |
| (° C.) | 1336mzz | 1336mzz | Neopentane | Neopentane | (psia) | (psia) | 100% |
| −40 | 0.000 | 0.0000 | 1.0000 | 1.0000 | 1.6172 | 1.6172 | 0.00% |
| −40 | 0.002 | 0.0031 | 0.9980 | 0.9969 | 1.6190 | 1.6184 | 0.04% |
| −40 | 0.100 | 0.0909 | 0.9000 | 0.9091 | 1.6437 | 1.6413 | 0.15% |
| −40 | 0.148 | 0.1110 | 0.8520 | 0.8890 | 1.6360 | 1.5870 | 2.99% |
| −40 | 0.150 | 0.1117 | 0.8500 | 0.8883 | 1.6356 | 1.5824 | 3.25% |
| −40 | 0.160 | 0.1150 | 0.8400 | 0.8850 | 1.6334 | 1.5550 | 4.80% |
| −40 | 0.162 | 0.1156 | 0.8380 | 0.8844 | 1.6329 | 1.5487 | 5.15% |
| −40 | 0.998 | 0.9546 | 0.0020 | 0.0454 | 0.3663 | 0.3510 | 4.18% |
| −40 | 1.000 | 1.0000 | 0.0000 | 0.0000 | 0.3503 | 0.3503 | 0.00% |
| −20 | 0.000 | 0.0000 | 1.0000 | 1.0000 | 4.4342 | 4.4342 | 0.00% |
| −20 | 0.002 | 0.0035 | 0.9980 | 0.9965 | 4.4412 | 4.4382 | 0.07% |
| −20 | 0.100 | 0.1085 | 0.9000 | 0.8915 | 4.5869 | 4.5823 | 0.10% |
| −20 | 0.192 | 0.1510 | 0.8080 | 0.8490 | 4.5692 | 4.4375 | 2.88% |
| −20 | 0.194 | 0.1516 | 0.8060 | 0.8484 | 4.5682 | 4.4267 | 3.10% |
| −20 | 0.208 | 0.1560 | 0.7920 | 0.8440 | 4.5608 | 4.3389 | 4.86% |
| −20 | 0.210 | 0.1566 | 0.7900 | 0.8434 | 4.5597 | 4.3248 | 5.15% |
| −20 | 0.996 | 0.9387 | 0.0040 | 0.0613 | 1.3342 | 1.2616 | 5.44% |
| −20 | 0.998 | 0.9682 | 0.0020 | 0.0318 | 1.2958 | 1.2592 | 2.82% |
| −20 | 1.000 | 1.0000 | 0.0000 | 0.0000 | 1.2568 | 1.2568 | 0.00% |
| 0 | 0.000 | 0.0000 | 1.0000 | 1.0000 | 10.3222 | 10.3222 | 0.00% |
| 0 | 0.002 | 0.0039 | 0.9980 | 0.9961 | 10.3431 | 10.3328 | 0.10% |
| 0 | 0.100 | 0.1241 | 0.9000 | 0.8759 | 10.8575 | 10.7847 | 0.67% |
| 0 | 0.200 | 0.1786 | 0.8000 | 0.8214 | 10.8959 | 10.8317 | 0.59% |
| 0 | 0.238 | 0.1921 | 0.7620 | 0.8079 | 10.8625 | 10.5375 | 2.99% |
| 0 | 0.240 | 0.1928 | 0.7600 | 0.8072 | 10.8603 | 10.5148 | 3.18% |
| 0 | 0.256 | 0.1977 | 0.7440 | 0.8023 | 10.8415 | 10.3091 | 4.91% |
| 0 | 0.258 | 0.1983 | 0.7420 | 0.8017 | 10.8390 | 10.2807 | 5.15% |
| 0 | 0.994 | 0.9329 | 0.0060 | 0.0671 | 3.8553 | 3.6348 | 5.72% |
| 0 | 0.996 | 0.9541 | 0.0040 | 0.0459 | 3.7760 | 3.6280 | 3.92% |
| 0 | 0.998 | 0.9764 | 0.0020 | 0.0236 | 3.6957 | 3.6212 | 2.02% |
| 0 | 1.000 | 1.0000 | 0.0000 | 0.0000 | 3.6144 | 3.6144 | 0.00% |
| 20 | 0.000 | 0.0000 | 1.0000 | 1.0000 | 21.1399 | 21.1399 | 0.00% |
| 20 | 0.002 | 0.0043 | 0.9980 | 0.9957 | 21.1914 | 21.1640 | 0.13% |
| 20 | 0.100 | 0.1376 | 0.9000 | 0.8624 | 22.6006 | 22.2674 | 1.47% |
| 20 | 0.200 | 0.2008 | 0.8000 | 0.7992 | 22.8812 | 22.8811 | 0.00% |
| 20 | 0.282 | 0.2326 | 0.7180 | 0.7674 | 22.7823 | 22.1007 | 2.99% |
| 20 | 0.284 | 0.2333 | 0.7160 | 0.7667 | 22.7778 | 22.0583 | 3.16% |
| 20 | 0.302 | 0.2390 | 0.6980 | 0.7610 | 22.7337 | 21.6320 | 4.85% |
| 20 | 0.304 | 0.2396 | 0.6960 | 0.7604 | 22.7284 | 21.5803 | 5.05% |
| 20 | 0.992 | 0.9312 | 0.0080 | 0.0688 | 9.3530 | 8.8251 | 5.64% |
| 20 | 0.994 | 0.9473 | 0.0060 | 0.0527 | 9.2073 | 8.8088 | 4.33% |
| 20 | 0.996 | 0.9641 | 0.0040 | 0.0359 | 9.0599 | 8.7925 | 2.95% |
| 20 | 0.998 | 0.9816 | 0.0020 | 0.0184 | 8.9109 | 8.7762 | 1.51% |
| 20 | 1.000 | 1.0000 | 0.0000 | 0.0000 | 8.7600 | 8.7600 | 0.00% |
| 29.90 | 0.000 | 0.0000 | 1.0000 | 1.0000 | 28.9936 | 28.9936 | 0.00% |
| 29.90 | 0.002 | 0.0044 | 0.9980 | 0.9956 | 29.0702 | 29.0283 | 0.14% |
| 29.90 | 0.100 | 0.1436 | 0.9000 | 0.8564 | 31.2508 | 30.6506 | 1.92% |
| 29.90 | 0.200 | 0.2109 | 0.8000 | 0.7891 | 31.7848 | 31.7473 | 0.12% |
| 29.90 | 0.300 | 0.2514 | 0.7000 | 0.7486 | 31.6654 | 30.7977 | 2.74% |
| 29.90 | 0.302 | 0.2521 | 0.6980 | 0.7479 | 31.6593 | 30.7436 | 2.89% |
| 29.90 | 0.304 | 0.2527 | 0.6960 | 0.7473 | 31.6530 | 30.6882 | 3.05% |
| 29.90 | 0.326 | 0.2599 | 0.6740 | 0.7401 | 31.5767 | 29.9999 | 4.99% |
| 29.90 | 0.328 | 0.2605 | 0.6720 | 0.7395 | 31.5691 | 29.9311 | 5.19% |
| 29.90 | 0.990 | 0.9240 | 0.0100 | 0.0760 | 13.8642 | 13.0165 | 6.11% |
| 29.90 | 0.992 | 0.9380 | 0.0080 | 0.0620 | 13.6749 | 12.9924 | 4.99% |
| 29.90 | 0.994 | 0.9526 | 0.0060 | 0.0474 | 13.4836 | 12.9683 | 3.82% |
| 29.90 | 0.996 | 0.9678 | 0.0040 | 0.0322 | 13.2902 | 12.9444 | 2.60% |
| 29.90 | 0.998 | 0.9836 | 0.0020 | 0.0164 | 13.0946 | 12.9205 | 1.33% |
| 29.90 | 1.000 | 1.0000 | 0.0000 | 0.0000 | 12.8968 | 12.8968 | 0.00% |
| 40 | 0.000 | 0.0000 | 1.0000 | 1.0000 | 39.1175 | 39.1175 | 0.00% |
| 40 | 0.002 | 0.0046 | 0.9980 | 0.9954 | 39.2292 | 39.1666 | 0.16% |
| 40 | 0.100 | 0.1494 | 0.9000 | 0.8506 | 42.5267 | 41.5039 | 2.41% |
| 40 | 0.200 | 0.2206 | 0.8000 | 0.7794 | 43.4682 | 43.2932 | 0.40% |
| 40 | 0.300 | 0.2640 | 0.7000 | 0.7360 | 43.4226 | 42.8014 | 1.43% |
| 40 | 0.324 | 0.2724 | 0.6760 | 0.7276 | 43.3303 | 42.0535 | 2.95% |
| 40 | 0.326 | 0.2731 | 0.6740 | 0.7269 | 43.3215 | 41.9801 | 3.10% |
| 40 | 0.348 | 0.2804 | 0.6520 | 0.7196 | 43.2138 | 41.0773 | 4.94% |
| 40 | 0.350 | 0.2811 | 0.6500 | 0.7189 | 43.2030 | 40.9877 | 5.13% |
| 40 | 0.990 | 0.9312 | 0.0100 | 0.0688 | 19.8257 | 18.7456 | 5.45% |
| 40 | 0.992 | 0.9440 | 0.0080 | 0.0560 | 19.5804 | 18.7109 | 4.44% |
| 40 | 0.994 | 0.9572 | 0.0060 | 0.0428 | 19.3326 | 18.6763 | 3.40% |
| 40 | 0.996 | 0.9710 | 0.0040 | 0.0290 | 19.0822 | 18.6418 | 2.31% |
| 40 | 0.998 | 0.9852 | 0.0020 | 0.0148 | 18.8290 | 18.6075 | 1.18% |
| 40 | 1.000 | 1.0000 | 0.0000 | 0.0000 | 18.5732 | 18.5732 | 0.00% |
| 60 | 0.000 | 0.0000 | 1.0000 | 1.0000 | 66.7508 | 66.7508 | 0.00% |
| 60 | 0.002 | 0.0048 | 0.9980 | 0.9952 | 66.9722 | 66.8431 | 0.19% |
| 60 | 0.050 | 0.0964 | 0.9500 | 0.9036 | 71.2049 | 69.0695 | 3.00% |
| 60 | 0.052 | 0.0994 | 0.9480 | 0.9006 | 71.3424 | 69.1623 | 3.06% |
| 60 | 0.100 | 0.1599 | 0.9000 | 0.8401 | 73.9384 | 71.3675 | 3.48% |
| 60 | 0.134 | 0.1919 | 0.8660 | 0.8081 | 75.1282 | 72.8669 | 3.01% |
| 60 | 0.136 | 0.1936 | 0.8640 | 0.8064 | 75.1851 | 72.9523 | 2.97% |
| 60 | 0.200 | 0.2385 | 0.8000 | 0.7615 | 76.4161 | 75.3962 | 1.33% |
| 60 | 0.300 | 0.2873 | 0.7000 | 0.7127 | 76.8076 | 76.6796 | 0.17% |
| 60 | 0.364 | 0.3117 | 0.6360 | 0.6883 | 76.4600 | 74.2548 | 2.88% |
| 60 | 0.366 | 0.3125 | 0.6340 | 0.6875 | 76.4433 | 74.1332 | 3.02% |
| 60 | 0.390 | 0.3209 | 0.6100 | 0.6791 | 76.2178 | 72.5078 | 4.87% |
| 60 | 0.392 | 0.3216 | 0.6080 | 0.6784 | 76.1969 | 72.3602 | 5.04% |
| 60 | 0.988 | 0.9319 | 0.0120 | 0.0681 | 37.8216 | 35.8393 | 5.24% |
| 60 | 0.990 | 0.9424 | 0.0100 | 0.0576 | 37.4342 | 35.7723 | 4.44% |
| 60 | 0.992 | 0.9532 | 0.0080 | 0.0468 | 37.0431 | 35.7055 | 3.61% |
| 60 | 0.994 | 0.9644 | 0.0060 | 0.0356 | 36.6482 | 35.6390 | 2.75% |
| 60 | 0.998 | 0.9878 | 0.0020 | 0.0122 | 35.8472 | 35.5067 | 0.95% |
| 60 | 1.000 | 1.0000 | 0.0000 | 0.0000 | 35.4409 | 35.4409 | 0.00% |
| 80 | 0.000 | 0.0000 | 1.0000 | 1.0000 | 106.7445 | 106.7445 | 0.00% |
| 80 | 0.002 | 0.0050 | 0.9980 | 0.9950 | 107.1575 | 106.9093 | 0.23% |
| 80 | 0.034 | 0.0737 | 0.9660 | 0.9263 | 112.9502 | 109.5782 | 2.99% |
| 80 | 0.036 | 0.0773 | 0.9640 | 0.9227 | 113.2653 | 109.7468 | 3.11% |
| 80 | 0.100 | 0.1694 | 0.9000 | 0.8306 | 121.0224 | 115.2064 | 4.81% |
| 80 | 0.192 | 0.2498 | 0.8080 | 0.7502 | 126.6249 | 122.7885 | 3.03% |
| 80 | 0.194 | 0.2511 | 0.8060 | 0.7489 | 126.6973 | 122.9397 | 2.97% |
| 80 | 0.200 | 0.2551 | 0.8000 | 0.7449 | 126.9045 | 123.3872 | 2.77% |
| 80 | 0.300 | 0.3092 | 0.7000 | 0.6908 | 128.6011 | 128.4880 | 0.09% |
| 80 | 0.404 | 0.3519 | 0.5960 | 0.6481 | 127.9126 | 124.1362 | 2.95% |
| 80 | 0.406 | 0.3526 | 0.5940 | 0.6474 | 127.8807 | 123.9332 | 3.09% |
| 80 | 0.430 | 0.3617 | 0.5700 | 0.6383 | 127.4454 | 121.2404 | 4.87% |
| 80 | 0.432 | 0.3624 | 0.5680 | 0.6376 | 127.4049 | 120.9974 | 5.03% |
| 80 | 0.986 | 0.9330 | 0.0140 | 0.0670 | 66.4262 | 63.0507 | 5.08% |
| 80 | 0.988 | 0.9418 | 0.0120 | 0.0582 | 65.8393 | 62.9298 | 4.42% |
| 80 | 0.992 | 0.9602 | 0.0080 | 0.0398 | 64.6508 | 62.6893 | 3.03% |
| 80 | 0.994 | 0.9698 | 0.0060 | 0.0302 | 64.0491 | 62.5698 | 2.31% |
| 80 | 0.998 | 0.9896 | 0.0020 | 0.0104 | 62.8306 | 62.3319 | 0.79% |
| 80 | 1.000 | 1.0000 | 0.0000 | 0.0000 | 62.2136 | 62.2136 | 0.00% |
| 100 | 0.000 | 0.0000 | 1.0000 | 1.0000 | 162.0606 | 162.0606 | 0.00% |
| 100 | 0.002 | 0.0052 | 0.9980 | 0.9948 | 162.8079 | 162.3479 | 0.28% |
| 100 | 0.024 | 0.0565 | 0.9760 | 0.9435 | 170.4614 | 165.5563 | 2.88% |
| 100 | 0.026 | 0.0607 | 0.9740 | 0.9393 | 171.1079 | 165.8523 | 3.07% |
| 100 | 0.050 | 0.1062 | 0.9500 | 0.8938 | 178.2764 | 169.4602 | 4.95% |
| 100 | 0.052 | 0.1096 | 0.9480 | 0.8904 | 178.8269 | 169.7653 | 5.07% |
| 100 | 0.100 | 0.1787 | 0.9000 | 0.8213 | 190.1334 | 177.2807 | 6.76% |
| 100 | 0.200 | 0.2722 | 0.8000 | 0.7278 | 204.4969 | 193.6178 | 5.32% |
| 100 | 0.208 | 0.2779 | 0.7920 | 0.7221 | 205.2348 | 194.9091 | 5.03% |
| 100 | 0.210 | 0.2793 | 0.7900 | 0.7207 | 205.4114 | 195.2300 | 4.96% |
| 100 | 0.256 | 0.3084 | 0.7440 | 0.6916 | 208.6711 | 202.2679 | 3.07% |
| 100 | 0.258 | 0.3096 | 0.7420 | 0.6904 | 208.7805 | 202.5525 | 2.98% |
| 100 | 0.300 | 0.3324 | 0.7000 | 0.6676 | 210.5275 | 207.8247 | 1.28% |
| 100 | 0.400 | 0.3780 | 0.6000 | 0.6220 | 211.0931 | 209.6264 | 0.69% |
| 100 | 0.440 | 0.3945 | 0.5600 | 0.6055 | 210.1069 | 203.9804 | 2.92% |
| 100 | 0.442 | 0.3953 | 0.5580 | 0.6047 | 210.0407 | 203.6103 | 3.06% |
| 100 | 0.984 | 0.9342 | 0.0160 | 0.0658 | 109.3571 | 103.8668 | 5.02% |
| 100 | 0.986 | 0.9417 | 0.0140 | 0.0583 | 108.4855 | 103.6575 | 4.45% |
| 100 | 0.990 | 0.9574 | 0.0100 | 0.0426 | 106.7243 | 103.2415 | 3.26% |
| 100 | 0.992 | 0.9656 | 0.0080 | 0.0344 | 105.8347 | 103.0346 | 2.65% |
| 100 | 0.998 | 0.9911 | 0.0020 | 0.0089 | 103.1293 | 102.4189 | 0.69% |
| 100 | 1.000 | 1.0000 | 0.0000 | 0.0000 | 102.2152 | 102.2152 | 0.00% |
| 120 | 0.000 | 0.0000 | 1.0000 | 1.0000 | 236.1168 | 236.1168 | 0.00% |
| 120 | 0.002 | 0.0054 | 0.9980 | 0.9946 | 237.4794 | 236.6231 | 0.36% |
| 120 | 0.018 | 0.0451 | 0.9820 | 0.9549 | 248.1231 | 240.7570 | 2.97% |
| 120 | 0.020 | 0.0497 | 0.9800 | 0.9503 | 249.4243 | 241.2844 | 3.26% |
| 120 | 0.032 | 0.0760 | 0.9680 | 0.9240 | 257.1173 | 244.4997 | 4.91% |
| 120 | 0.034 | 0.0801 | 0.9660 | 0.9199 | 258.3829 | 245.0444 | 5.16% |
| 120 | 0.100 | 0.1903 | 0.9000 | 0.8097 | 290.9384 | 264.6514 | 9.04% |
| 120 | 0.160 | 0.2557 | 0.8400 | 0.7443 | 300.5716 | 285.3887 | 5.05% |
| 120 | 0.162 | 0.2575 | 0.8380 | 0.7425 | 300.8051 | 285.8125 | 4.98% |
| 120 | 0.200 | 0.2891 | 0.8000 | 0.7109 | 304.4655 | 292.5199 | 3.92% |
| 120 | 0.232 | 0.3118 | 0.7680 | 0.6882 | 306.5936 | 297.3575 | 3.01% |
| 120 | 0.234 | 0.3131 | 0.7660 | 0.6869 | 306.7023 | 297.6413 | 2.95% |
| 120 | 0.300 | 0.3523 | 0.7000 | 0.6477 | 308.9822 | 305.5498 | 1.11% |
| 120 | 0.400 | 0.4009 | 0.6000 | 0.5991 | 308.7450 | 308.7833 | −0.01% |
| 120 | 0.500 | 0.4448 | 0.5000 | 0.5552 | 305.0445 | 295.9952 | 2.97% |
| 120 | 0.502 | 0.4457 | 0.4980 | 0.5543 | 304.9360 | 295.5923 | 3.06% |
| 120 | 0.538 | 0.4618 | 0.4620 | 0.5382 | 302.7328 | 287.6782 | 4.97% |
| 120 | 0.540 | 0.4627 | 0.4600 | 0.5373 | 302.5961 | 287.2072 | 5.09% |
| 120 | 0.982 | 0.9354 | 0.0180 | 0.0646 | 171.3352 | 162.5178 | 5.15% |
| 120 | 0.984 | 0.9420 | 0.0160 | 0.0580 | 170.0262 | 162.1598 | 4.63% |
| 120 | 0.988 | 0.9556 | 0.0120 | 0.0444 | 167.3917 | 161.4485 | 3.55% |
| 120 | 0.990 | 0.9627 | 0.0100 | 0.0373 | 166.0660 | 161.0952 | 2.99% |
| 120 | 0.998 | 0.9922 | 0.0020 | 0.0078 | 160.7064 | 159.6975 | 0.63% |
| 120 | 1.000 | 1.0000 | 0.0000 | 0.0000 | 159.3520 | 159.3520 | 0.00% |

Near-azeotropes formed between Z-HFO-1336mzz and neopentane at 1 atm are shown in Table 11. Table 11 shows representative data in increments of 0.10 Z-HFO-1336mzz liquid molar composition, or the boundaries of near-azeotropic behavior.

TABLE 11

| | | Liquid Mole | Vapor Mole | | | | | |
|---|---|---|---|---|---|---|---|---|
| | | Fraction | Fraction | Liquid Mole | Vapor Mole | Bubble Point | Dew Point | [(BP- |
| Pressure | Temp | Z-HFO- | Z-HFO- | Fraction | Fraction | Pressure | Pressure | DP)/BP]* |
| (atm) | (° C.) | 1336mzz | 1336mzz | Neopentane | Neopentane | (psia) | (psia) | 100% |
| 1.00 | 9.5 | 0.0000 | 0.0000 | 1.0000 | 1.0000 | 14.6960 | 14.6960 | 0.00% |
| 1.00 | 9.4 | 0.0020 | 0.0041 | 0.9980 | 0.9959 | 14.6960 | 14.6793 | 0.11% |
| 1.00 | 7.8 | 0.2540 | 0.2075 | 0.7460 | 0.7925 | 14.6960 | 14.2731 | 2.88% |
| 1.00 | 7.8 | 0.2560 | 0.2082 | 0.7440 | 0.7918 | 14.6960 | 14.2473 | 3.05% |
| 1.00 | 7.9 | 0.2740 | 0.2139 | 0.7260 | 0.7861 | 14.6960 | 13.9822 | 4.86% |
| 1.00 | 7.9 | 0.2760 | 0.2145 | 0.7240 | 0.7855 | 14.6960 | 13.9495 | 5.08% |
| 1.00 | 31.5 | 0.9900 | 0.9252 | 0.0100 | 0.0748 | 14.6960 | 13.8141 | 6.00% |
| 1.00 | 31.9 | 0.9920 | 0.9393 | 0.0080 | 0.0607 | 14.6960 | 13.9794 | 4.88% |
| 1.00 | 32.2 | 0.9940 | 0.9538 | 0.0060 | 0.0462 | 14.6960 | 14.1500 | 3.72% |
| 1.00 | 32.6 | 0.9960 | 0.9687 | 0.0040 | 0.0313 | 14.6960 | 14.3261 | 2.52% |
| 1.00 | 33.0 | 0.9980 | 0.9841 | 0.0020 | 0.0159 | 14.6960 | 14.5080 | 1.28% |
| 1.00 | 33.4 | 1.0000 | 1.0000 | 0.0000 | 0.0000 | 14.6960 | 14.6960 | 0.00% |

The data in Table 10-11 are broadly summarized in Table 12 which shows azeotrope-like compositions, based on the equation [(BP−VP)/BP]×100≤3.

TABLE 12

| | | Liquid Mole Percentage |
|---|---|---|
| | Temp | Range Z-HFO-1336mzz |
| Components | (° C.) | (Remainder Neopentane) |
| Z-HFO-1336mzz/ | −40 | 0.002 to 0.148 |
| Neopentane | | |
| Z-HFO-1336mzz/ | −20 | 0.002 to 0.192 |
| Neopentane | | |
| Z-HFO-1336mzz/ | 0 | 0.002 to 0.238 |
| Neopentane | | |
| Z-HFO-1336mzz/ | 20 | 0.002 to 0.382 and |
| Neopentane | | 0.996 to 0.998 |
| Z-HFO-1336mzz/ | 29.90 | 0.002 to 0.302 and |
| Neopentane | | 0.996 to 0.998 |
| Z-HFO-1336mzz/ | 40 | 0.002 to 0.324 and |
| Neopentane | | 0.996 to 0.998 |
| Z-HFO-1336mzz/ | 60 | 0.002 to 0.050 and |
| Neopentane | | 0.136 to 0.364 and |
| | | 0.994 to 0.998 |
| Z-HFO-1336mzz/ | 80 | 0.002 to 0.034 and |
| Neopentane | | 0.194 to 0.404 and |
| | | 0.994 to 0.998 |
| Z-HFO-1336mzz/ | 100 | 0.002 to 0.024 and |
| Neopentane | | 0.258 to 0.440 and |
| | | 0.992 to 0.998 |
| Z-HFO-1336mzz/ | 120 | 0.002 to 0.018 and |
| Neopentane | | 0.234 to 0.050 and |
| | | 0.990 to 0.998 |

### Other Embodiments

1. In some embodiments, the present application provides a composition, comprising:
i) neopentane; and
ii) a compound selected from E-1,1,1,4,4,4-hexafluoro-2-butene and Z-1,1,1,4,4,4-hexafluoro-2-butene,
wherein the E-1,1,1,4,4,4-hexafluoro-2-butene or Z-1,1,1,4,4,4-hexafluoro-2-butene is present in the composition in an amount effective to form an azeotrope composition or an azeotrope-like composition with the neopentane.

2. The composition of embodiment 1, wherein the composition comprises neopentane and E-1,1,1,4,4,4-hexafluoro-2-butene, wherein the E-1,1,1,4,4,4-hexafluoro-2-butene is present in the composition in an amount effective to form an azeotrope composition or an azeotrope-like composition with the neopentane.

3. The composition of embodiment 1 or 2, wherein the composition comprises from about 40 to about 60 mol % neopentane and about 60 to about 40 mol % E-1,1,1,4,4,4-hexafluoro-2-butene.

4. The composition of any one of embodiments 1 to 3, which has a boiling point of from about −40° C. to about 120° C. at a pressure of from about 2 psi to about 390 psi.

5. The composition of any one of embodiments 1 to 4, which is an azeotrope composition.

6. The composition of embodiment 1 or 2, wherein the composition comprises from about 40 to about 50 mol % neopentane and about 60 to about 50 mol % E-1,1,1,4,4,4-hexafluoro-2-butene.

7. The composition of any one of embodiments 1, 2, and 6, which has a boiling point of from about 0.9° C. to about 128° C. at a pressure of from about 1 atm to about 30 atm.

8. The composition of any one of embodiments 1 to 7, which is an azeotrope composition.

9. The composition embodiment 1 or 2, wherein the composition comprises from about 98.4 to about 99.8 mol % neopentane and about 1.6 to about 0.2 mol % E-1,1,1,4,4,4-hexafluoro-2-butene.

10. The composition of any one of embodiments 1, 2, and 9, which has a boiling point of from about 8.3° C. to about 9.3° C. at a pressure of about 1 atm.

11. The composition of embodiment 1 or 2, wherein the composition comprises from about 38.4 to about 62.6 mol % neopentane and about 65.2 to about 37.4 mol % E-1,1,1,4,4,4-hexafluoro-2-butene.

12. The composition any one of embodiments 1, 2, and 11, which has a boiling point of from about 0.9° C. to about 1.2° C. at a pressure of about 1 atm.

13. The composition of embodiment 1 or 2, wherein the composition comprises from about 0.2 to about 2.8 mol % neopentane and about 99.8 to about 97.2 mol % E-1,1,1,4,4,4-hexafluoro-2-butene.

14. The composition of any one of embodiments 1, 2, and 13, which has a boiling point of from about 6.3° C. to about 7.4° C. at a pressure of about 1 atm.

15. The composition of embodiment 1 or 2, wherein the composition comprises:
from about 99.8 to about 98.2 mol % neopentane and about 0.2 to about 1.8 mol % E-1,1,1,4,4,4-hexafluoro-2-butene; or
from about 71.6 to about 47.6 mol % neopentane and about 28.4 to about 52.4 mol % E-1,1,1,4,4,4-hexafluoro-2-butene; or
from about 1.2 to about 0.2 mol % neopentane and about 98.8 to about 99.8 mol % E-1,1,1,4,4,4-hexafluoro-2-butene; or
from about 99.8 to about 98.4 mol % neopentane and about 0.2 to about 1.6 mol % E-1,1,1,4,4,4-hexafluoro-2-butene; or
from about 66.6 to about 40.8 mol % neopentane and about 33.4 to about 59.2 mol % E-1,1,1,4,4,4-hexafluoro-2-butene; or
from about 1.8 to about 0.2 mol % neopentane and about 98.2 to about 99.8 mol % E-1,1,1,4,4,4-hexafluoro-2-butene; or
from about 62.8 to about 35.2 mol % neopentane and about 37.2 to about 64.8 mol % E-1,1,1,4,4,4-hexafluoro-2-butene; or
from about 2.6 to about 0.2 mol % neopentane and about 97.4 to about 99.8 mol % E-1,1,1,4,4,4-hexafluoro-2-butene; or
from about 59.8 to about 30.2 mol % neopentane and about 40.2 to about 69.8 mol % E-1,1,1,4,4,4-hexafluoro-2-butene; or
from about 3.4 to about 0.2 mol % neopentane and about 96.6 to about 99.8 mol % E-1,1,1,4,4,4-hexafluoro-2-butene; or
from about 58.4 to about 28.2 mol % neopentane and about 41.6 to about 71.8 mol % E-1,1,1,4,4,4-hexafluoro-2-butene; or
from about 3.8 to about 0.2 mol % neopentane and about 96.2 to about 99.8 mol % E-1,1,1,4,4,4-hexafluoro-2-butene; or
from about 57.2 to about 26.4 mol % neopentane and about 42.8 to about 73.6 mol % E-1,1,1,4,4,4-hexafluoro-2-butene; or
from about 4.4 to about 0.2 mol % neopentane and about 95.6 to about 99.8 mol % E-1,1,1,4,4,4-hexafluoro-2-butene; or
from about 55.4 to about 23.6 mol % neopentane and about 44.6 to about 76.4 mol % E-1,1,1,4,4,4-hexafluoro-2-butene; or
from about 5.2 to about 99.1 mol % neopentane and about 94.8 to about 0.9 mol % E-1,1,1,4,4,4-hexafluoro-2-butene; or
from about 99.8 to about 98.6 mol % neopentane and about 0.2 to about 1.4 mol % E-1,1,1,4,4,4-hexafluoro-2-butene; or
from about 53.8 to about 23.2 mol % neopentane and about 46.2 to about 76.8 mol % E-1,1,1,4,4,4-hexafluoro-2-butene; or
from about 5.4 to about 0.2 mol % neopentane and about 94.6 to about 99.8 mol % E-1,1,1,4,4,4-hexafluoro-2-butene; or
from about 56 to about 24.4 mol % neopentane and about 44.0 to about 75.6 mol % E-1,1,1,4,4,4-hexafluoro-2-butene; or
from about 4.6 to about 0.2 mol % neopentane and about 95.4 to about 99.8 mol % E-1,1,1,4,4,4-hexafluoro-2-butene; or
from about 57.2 to about 3.8 mol % neopentane and about 42.8 to about 96.2 mol % E-1,1,1,4,4,4-hexafluoro-2-butene; or
from about 2.6 to about 0.2 mol % neopentane and about 97.4 to about 99.8 mol % E-1,1,1,4,4,4-hexafluoro-2-butene.

16. The composition any one of embodiments 1, 2, and 15, which has a boiling point of from about −20° C. to about 120° C. at a pressure of about 1 atm.

17. The composition of any one of embodiments 1, 2, and 9 to 16, which is an azeotrope-like composition.

18. The composition of embodiment 1, wherein the composition comprises neopentane and Z-1,1,1,4,4,4-hexafluoro-2-butene, wherein the Z-1,1,1,4,4,4-hexafluoro-2-butene is present in the composition in an amount effective to form an azeotrope composition or an azeotrope-like composition with the neopentane.

19. The composition of embodiment 1 or 18, wherein the composition comprises from about 60 to about 93 mol % neopentane and about 40 to about 7 mol % Z-1,1,1,4,4,4-hexafluoro-2-butene.

20. The composition of any one of embodiments 1, 18, and 19, which has a boiling point of from about −40° C. to about 120° C. at a pressure of from about 1.5 psi to about 310 psi.

21. The composition of embodiment 1 or 18, wherein the composition comprises from about 56 to about 83 mol % neopentane and about 44 to about 17 mol % Z-1,1,1,4,4,4-hexafluoro-2-butene.

22. The composition of any one of embodiments 1, 18, and 21, which has a boiling point of from about 5° C. to about 145° C. at a pressure of from about 1 atm to about 30 atm.

23. The composition of any one of embodiments 1 and 18 to 21, which is an azeotrope composition.

24. The composition of embodiment 1 or 18, wherein the composition comprises from about 99.6 to about 79.2 mol % neopentane and about 0.4 to about 20.8 mol % Z-1,1,1,4,4,4-hexafluoro-2-butene.

25. The composition of any one of embodiments 1, 18, and 24, which has a boiling point of from about 7.8° C. to about 9.4° C. at a pressure of about 1 atm.

26. The composition of embodiment 1 or 18, wherein the composition comprises from about 3.2 to about 1.6 mol % neopentane and about 96.8 to about 98.4 mol % Z-1,1,1,4,4,4-hexafluoro-2-butene.

27. The composition of any one of embodiments 1, 18, and 26, which has a boiling point of from about 32.6° C. to about 33.0° C. at a pressure of about 1 atm.

28. The composition of embodiment 1 or 18, wherein the composition comprises:
from about 99.8 to about 85.2 mol % neopentane and about 0.2 to about 14.8 mol % Z-1,1,1,4,4,4-hexafluoro-2-butene; or
from about 99.8 to about 80.8 mol % neopentane and about 0.2 to about 19.2 mol % Z-1,1,1,4,4,4-hexafluoro-2-butene; or
from about 99.8 to about 76.2 mol % neopentane and about 0.2 to about 23.8 mol % Z-1,1,1,4,4,4-hexafluoro-2-butene; or
from about 99.8 to about 61.8 mol % neopentane and about 0.2 to about 38.2 mol % Z-1,1,1,4,4,4-hexafluoro-2-butene; or
from about 0.4 to about 0.2 mol % neopentane and about 99.6 to about 99.8 mol % Z-1,1,1,4,4,4-hexafluoro-2-butene; or
from about 99.8 to about 69.8 mol % neopentane and about 0.2 to about 30.2 mol % Z-1,1,1,4,4,4-hexafluoro-2-butene; or
from about 99.8 to about 67.6 mol % neopentane and about 0.2 to about 32.4 mol % Z-1,1,1,4,4,4-hexafluoro-2-butene; or
from about 99.8 to about 95.0 mol % neopentane and about 0.2 to about 5 mol % Z-1,1,1,4,4,4-hexafluoro-2-butene; or
from about 86.4 to about 63.6 mol % neopentane and about 13.6 to about 36.4 mol % Z-1,1,1,4,4,4-hexafluoro-2-butene; or
from about 0.4 to about 0.2 mol % neopentane and about 99.6 to about 99.8 mol % Z-1,1,1,4,4,4-hexafluoro-2-butene; or
from about 99.8 to about 96.6 mol % neopentane and about 0.2 to about 3.4 mol % Z-1,1,1,4,4,4-hexafluoro-2-butene; or
from about 80.6 to about 59.6 mol % neopentane and about 19.4 to about 40.4 mol % Z-1,1,1,4,4,4-hexafluoro-2-butene; or
from about 99.8 to about 97.6 mol % neopentane and about 0.2 to about 2.4 mol % Z-1,1,1,4,4,4-hexafluoro-2-butene; or
from about 74.2 to about 56.0 mol % neopentane and about 25.8 to about 44.0 mol % Z-1,1,1,4,4,4-hexafluoro-2-butene; or
from about 0.2 to about 0.8 mol % neopentane and about 99.2 to about 99.8 mol % Z-1,1,1,4,4,4-hexafluoro-2-butene; or
from about 99.8 to about 98.2 mol % neopentane and about 0.2 to about 1.8 mol % Z-1,1,1,4,4,4-hexafluoro-2-butene; or
from about 76.6 to about 50.0 mol % neopentane and about 23.4 to about 50.0 mol % Z-1,1,1,4,4,4-hexafluoro-2-butene; or
from about 1.0 to about 0.2 mol % neopentane and about 99.0 to about 99.8 mol % Z-1,1,1,4,4,4-hexafluoro-2-butene.

29. The composition of any one of embodiments 1, 18, and 28, which has a boiling point of from about −20° C. to about 120° C. at a pressure of about 1 atm.

30. The composition of any one of embodiments 1, 18, and 24 to 29, which is an azeotrope-like composition.

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims. It should be appreciated by those persons having ordinary skill in the art(s) to which the present invention relates that any of the features described herein in respect of any particular aspect and/or embodiment of the present invention can be combined with one or more of any of the other features of any other aspects and/or embodiments of the present invention described herein, with modifications as appropriate to ensure compatibility of the combinations. Such combinations are considered to be part of the present invention contemplated by this disclosure.

1. A composition, comprising:
i) neopentane; and
ii) a compound selected from E-1,1,1,4,4,4-hexafluoro-2-butene and Z-1,1,1,4,4,4-hexafluoro-2-butene,
wherein the E-1,1,1,4,4,4-hexafluoro-2-butene or Z-1,1,1,4,4,4-hexafluoro-2-butene is present in the composition in an amount effective to form an azeotrope composition or an azeotrope-like composition with the neopentane.

2. The composition of claim 1, wherein the composition comprises neopentane and E-1,1,1,4,4,4-hexafluoro-2-butene, wherein the E-1,1,1,4,4,4-hexafluoro-2-butene is present in the composition in an amount effective to form an azeotrope composition or an azeotrope-like composition with the neopentane.

3. The composition of claim 2, wherein the composition comprises an azeotrope of from about 40 to about 60 mol % neopentane and about 60 to about 40 mol % E-1,1,1,4,4,4-hexafluoro-2-butene.

4. The composition of claim 3, which has a boiling point of from about −40° C. to about 120° C. at a pressure of from about 2 psi to about 390 psi.

5. (canceled)

6. (canceled)

7. (canceled)

8. (canceled)

9. The composition of claim 2, wherein the composition comprises an azeotrope-like composition of from about 98.4 to about 99.8 mol % neopentane and about 1.6 to about 0.2 mol % E-1,1,1,4,4,4-hexafluoro-2-butene.

10. The composition of claim 9, which has a boiling point of from about 8.3° C. to about 9.3° C. at a pressure of about 1 atm.

11. (canceled)

12. The composition of claim 2, wherein the composition comprises an azeotrope-like composition of from about 38.4 to about 62.6 mol % neopentane and about 65.2 to about 37.4 mol % E-1,1,1,4,4,4-hexafluoro-2-butene.

13. (canceled)

14. (canceled)

15. (canceled)

16. (canceled)

17. (canceled)

18. The composition of claim 2, wherein the composition comprises an azeotrope-like composition of:
from about 99.8 to about 98.2 mol % neopentane and about 0.2 to about 1.8 mol % E-1,1,1,4,4,4-hexafluoro-2-butene; or
from about 71.6 to about 47.6 mol % neopentane and about 28.4 to about 52.4 mol % E-1,1,1,4,4,4-hexafluoro-2-butene; or
from about 1.2 to about 0.2 mol % neopentane and about 98.8 to about 99.8 mol % E-1,1,1,4,4,4-hexafluoro-2-butene; or
from about 99.8 to about 98.4 mol % neopentane and about 0.2 to about 1.6 mol % E-1,1,1,4,4,4-hexafluoro-2-butene; or
from about 66.6 to about 40.8 mol % neopentane and about 33.4 to about 59.2 mol % E-1,1,1,4,4,4-hexafluoro-2-butene; or
from about 1.8 to about 0.2 mol % neopentane and about 98.2 to about 99.8 mol % E-1,1,1,4,4,4-hexafluoro-2-butene; or
from about 62.8 to about 35.2 mol % neopentane and about 37.2 to about 64.8 mol % E-1,1,1,4,4,4-hexafluoro-2-butene; or
from about 2.6 to about 0.2 mol % neopentane and about 97.4 to about 99.8 mol % E-1,1,1,4,4,4-hexafluoro-2-butene; or
from about 59.8 to about 30.2 mol % neopentane and about 40.2 to about 69.8 mol % E-1,1,1,4,4,4-hexafluoro-2-butene; or
from about 3.4 to about 0.2 mol % neopentane and about 96.6 to about 99.8 mol % E-1,1,1,4,4,4-hexafluoro-2-butene; or
from about 58.4 to about 28.2 mol % neopentane and about 41.6 to about 71.8 mol % E-1,1,1,4,4,4-hexafluoro-2-butene; or
from about 3.8 to about 0.2 mol % neopentane and about 96.2 to about 99.8 mol % E-1,1,1,4,4,4-hexafluoro-2-butene; or
from about 57.2 to about 26.4 mol % neopentane and about 42.8 to about 73.6 mol % E-1,1,1,4,4,4-hexafluoro-2-butene; or
from about 4.4 to about 0.2 mol % neopentane and about 95.6 to about 99.8 mol % E-1,1,1,4,4,4-hexafluoro-2-butene; or
from about 55.4 to about 23.6 mol % neopentane and about 44.6 to about 76.4 mol % E-1,1,1,4,4,4-hexafluoro-2-butene; or
from about 5.2 to about 99.1 mol % neopentane and about 94.8 to about 0.9 mol % E-1,1,1,4,4,4-hexafluoro-2-butene; or
from about 99.8 to about 98.6 mol % neopentane and about 0.2 to about 1.4 mol % E-1,1,1,4,4,4-hexafluoro-2-butene; or
from about 53.8 to about 23.2 mol % neopentane and about 46.2 to about 76.8 mol % E-1,1,1,4,4,4-hexafluoro-2-butene; or
from about 5.4 to about 0.2 mol % neopentane and about 94.6 to about 99.8 mol % E-1,1,1,4,4,4-hexafluoro-2-butene; or
from about 56 to about 24.4 mol % neopentane and about 44.0 to about 75.6 mol % E-1,1,1,4,4,4-hexafluoro-2-butene; or
from about 4.6 to about 0.2 mol % neopentane and about 95.4 to about 99.8 mol % E-1,1,1,4,4,4-hexafluoro-2-butene; or
from about 57.2 to about 3.8 mol % neopentane and about 42.8 to about 96.2 mol % E-1,1,1,4,4,4-hexafluoro-2-butene; or
from about 2.6 to about 0.2 mol % neopentane and about 97.4 to about 99.8 mol % E-1,1,1,4,4,4-hexafluoro-2-butene.

19. The composition of claim 18, which has a boiling point of from about −20° C. to about 120° C. at a pressure of about 1 atm.

20. (canceled)

21. The composition of claim 1, wherein the composition comprises neopentane and Z-1,1,1,4,4,4-hexafluoro-2-butene, wherein the Z-1,1,1,4,4,4-hexafluoro-2-butene is present in the composition in an amount effective to form an azeotrope composition or an azeotrope-like composition with the neopentane.

22. The composition of claim 21, wherein the composition comprises an azeotrope of from about 60 to about 93 mol % neopentane and about 40 to about 7 mol % Z-1,1,1,4,4,4-hexafluoro-2-butene.

23. The composition of claim 22, which has a boiling point of from about −40° C. to about 120° C. at a pressure of from about 1.5 psi to about 310 psi.

24. (canceled)

25. (canceled)

26. (canceled)

27. (canceled)

28. The composition of claim 21, wherein the composition comprises an azeotrope-like composition of from about 99.6 to about 79.2 mol % neopentane and about 0.4 to about 20.8 mol % Z-1,1,1,4,4,4-hexafluoro-2-butene.

29. The composition of claim 28, which has a boiling point of from about 7.8° C. to about 9.4° C. at a pressure of about 1 atm.

30. (canceled)

31. The composition of claim 21, wherein the composition comprises an azeotrope-like composition of from about 3.2 to about 1.6 mol % neopentane and about 96.8 to about 98.4 mol % Z-1,1,1,4,4,4-hexafluoro-2-butene.

32. The composition of claim 31, which has a boiling point of from about 32.6° C. to about 33.0° C. at a pressure of about 1 atm.

33. (canceled)

34. The composition of claim 21, wherein the composition comprises an azeotrope of:
from about 99.8 to about 85.2 mol % neopentane and about 0.2 to about 14.8 mol % Z-1,1,1,4,4,4-hexafluoro-2-butene; or
from about 99.8 to about 80.8 mol % neopentane and about 0.2 to about 19.2 mol % Z-1,1,1,4,4,4-hexafluoro-2-butene; or
from about 99.8 to about 76.2 mol % neopentane and about 0.2 to about 23.8 mol % Z-1,1,1,4,4,4-hexafluoro-2-butene; or
from about 99.8 to about 61.8 mol % neopentane and about 0.2 to about 38.2 mol % Z-1,1,1,4,4,4-hexafluoro-2-butene; or
from about 0.4 to about 0.2 mol % neopentane and about 99.6 to about 99.8 mol % Z-1,1,1,4,4,4-hexafluoro-2-butene; or
from about 99.8 to about 69.8 mol % neopentane and about 0.2 to about 30.2 mol % Z-1,1,1,4,4,4-hexafluoro-2-butene; or
from about 99.8 to about 67.6 mol % neopentane and about 0.2 to about 32.4 mol % Z-1,1,1,4,4,4-hexafluoro-2-butene; or
from about 99.8 to about 95.0 mol % neopentane and about 0.2 to about 5 mol % Z-1,1,1,4,4,4-hexafluoro-2-butene; or
from about 86.4 to about 63.6 mol % neopentane and about 13.6 to about 36.4 mol % Z-1,1,1,4,4,4-hexafluoro-2-butene; or
from about 0.4 to about 0.2 mol % neopentane and about 99.6 to about 99.8 mol % Z-1,1,1,4,4,4-hexafluoro-2-butene; or
from about 99.8 to about 96.6 mol % neopentane and about 0.2 to about 3.4 mol % Z-1,1,1,4,4,4-hexafluoro-2-butene; or
from about 80.6 to about 59.6 mol % neopentane and about 19.4 to about 40.4 mol % Z-1,1,1,4,4,4-hexafluoro-2-butene; or
from about 99.8 to about 97.6 mol % neopentane and about 0.2 to about 2.4 mol % Z-1,1,1,4,4,4-hexafluoro-2-butene; or
from about 74.2 to about 56.0 mol % neopentane and about 25.8 to about 44.0 mol % Z-1,1,1,4,4,4-hexafluoro-2-butene; or
from about 0.2 to about 0.8 mol % neopentane and about 99.2 to about 99.8 mol % Z-1,1,1,4,4,4-hexafluoro-2-butene; or
from about 99.8 to about 98.2 mol % neopentane and about 0.2 to about 1.8 mol % Z-1,1,1,4,4,4-hexafluoro-2-butene; or
from about 76.6 to about 50.0 mol % neopentane and about 23.4 to about 50.0 mol % Z-1,1,1,4,4,4-hexafluoro-2-butene; or
from about 1.0 to about 0.2 mol % neopentane and about 99.0 to about 99.8 mol % Z-1,1,1,4,4,4-hexafluoro-2-butene.

35. The composition of claim 34, which has a boiling point of from about −20° C. to about 120° C. at a pressure of about 1 atm.

36. (canceled)
